(19) United States
(12) Patent Application Publication
(10) Pub. No.: US 2017/0140108 A1
(43) Pub. Date: May 18, 2017

(54) DEVICE FOR PROVIDING HEALTH MANAGEMENT SERVICE AND METHOD THEREOF

(71) Applicant: Samsung Electronics Co., Ltd, Gyeonggi-do (KR)

(72) Inventors: Kyung Hee Lee, Gyeonggi-do (KR); Hae Dong Lee, Daegu (KR); Jae Woong Chun, Gyeonggi-do (KR); Won Suk Choi, Seoul (KR)

(21) Appl. No.: 15/355,000

(22) Filed: Nov. 17, 2016

(30) Foreign Application Priority Data
Nov. 17, 2015 (KR) 10-2015-0161308

(51) Int. Cl. G06F 19/00; G06F 3/0482

(52) U.S. Cl. CPC G06F 19/324; G06F 3/0482

(57) ABSTRACT

A method performed in an electronic device includes displaying, on a display operatively connected to the electronic device, a service indication corresponding to a service to be provided through an application. The service indication including a first health information indication corresponding to first health information and a second health information indication corresponding to second health information. The method further includes obtaining an input to the displayed service indication, and allowing the application access to the first health information and the second health information based on the input. Another embodiment is an electronic device including a display circuit configured to display a health management UI, a user input circuit configured to obtain a user input, and a processor connected with the display circuit and the user input circuit. The processor configured to group at least one health information item corresponding to a service that a health management application can provide.

### CROSS-REFERENCE TO RELATED APPLICATION(S) AND CLAIM OF PRIORITY

The present application is related to and claims the benefit under 35 U.S.C. §119(a) of a Korean patent application filed on Nov. 17, 2015 in the Korean Intellectual Property Office and assigned Serial number 10-2015-0161308, the entire disclosure of which is hereby incorporated by reference.

### TECHNICAL FIELD

The present disclosure relates to an electronic device that provides a health management service and a method for operating the same.

### BACKGROUND

With developments of information and communication technology, network devices such as a base station and the like are installed throughout the country. An electronic device sends and receives data to and from another electronic device over a network, and thus a user utilizes the network freely anywhere in the country.

Various kinds of electronic devices provide a variety of functions in accordance with the recent trend of the digital convergence. For example, a smartphone supports an interne connection function over the network as well as a call function. Furthermore, the smartphone supports the following: a function of health management, a function of playing music or video, a function of shooting video, photo, and the like using an image sensor, etc.

Also, various user interface (UI) technologies have been developed for a method for effectively providing the user with the above-described convenient functions in the electronic device. The UI may be, for example, a graphic user interface (GUI) displayed in a screen of the electronic device.

When the electronic device executes an application, the application (e.g., service provider) needs to access (e.g., obtain or record health information) at least one health information of the user stored in the electronic device. The electronic device may provide the UI that allows the user to select the health information, which the application is permitted to access, from among at least one health information of the user stored in the electronic device.

The electronic device may not identify a health information indication corresponding to the at least one health information of the user stored in the electronic device and may display the health information indication through a display. Accordingly, it is difficult for the user to determine what is health information, which is necessary to receive the application, from among the at least one health information.

The user needs to determine the health information, which is necessary to receive the application, from among the at least one health information based on determination of the user. The electronic device may allow the application to access the determined health information based on a user input to the health information indication, which corresponds to the determined health information, from among at least one health information indication. Accordingly, since the user may mistake the health information, which is not necessary to be provided with the application, for the health information, which is necessary to receive the application, the user may accidentally and/or unnecessarily leak or disclose various health information of the user.

### SUMMARY

To address the above-discussed deficiencies, it is a primary object to provide an electronic device that provides a health management UI for determining health information that is necessary to provide an application and a method of operating the same.

In accordance with various embodiments of the present disclosure, a method performed in an electronic device may include displaying a service indication, which corresponds to a service to be provided through an application, through a display operatively connected with the electronic device in connection with a first health information indication corresponding to first health information and a second health information indication corresponding to second health information, obtaining an input to the displayed service indication, and allowing an access of the application to the first health information and the second health information based at least on the input.

In accordance with an aspect of the present disclosure, an electronic device includes a memory configured to store a service indication corresponding to a service to be provided through an application and a processor. The processor is configured to display the service indication and a first health information indication corresponding to first health information and a second health information indication corresponding to second health information through a display operatively connected with the processor in connection with the service indication, to obtain an input to the displayed service indication and to allow an access of the application to the first health information and the second health information based at least on the input.

In accordance with an aspect of the present disclosure, an electronic device includes a display circuit configured to display a health management user interface (UI), a user input circuit configured to obtain a user input from a user, and at least one processor electrically connected with the display circuit and the user input circuit. The at least one processor is configured to group at least one health information item, which corresponds to at least one service that a health management application is capable of providing, from among a plurality of health information items, to select the grouped at least one health information item in response to the obtained user input on the health management UI, and to provide the health management application with permission to access the selected at least one health information.

Other aspects, advantages, and salient features of the disclosure will become apparent to those skilled in the art from the following detailed description, which, taken in conjunction with the annexed drawings, discloses various embodiments of the present disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an electronic device in a network environment, according to various embodiments of the present disclosure;

FIG. 2 is a block diagram illustrating an electronic device, according to various embodiments of the present disclosure;

FIG. 3 is a block diagram illustrating a program module according to various embodiments of the present disclosure;

FIG. 4 is a block diagram illustrating an electronic device configured to provide a health management UI, according to various embodiments of the present disclosure;

FIG. 5 illustrates a table managed by a service management module, according to various embodiments of the present disclosure;

FIG. 6A illustrates a UI displaying a list of service providers associated with services that an electronic device is configured to provide, according to various embodiments of the present disclosure;

FIG. 6B illustrates a UI for displaying service indications corresponding to services which a selected service provider is configured to provide, and health information indications corresponding to health information used in each of the services, according to various embodiments of the present disclosure;

FIG. 7A illustrates a UI displaying a list of services that an electronic device is configured to provide, according to various embodiments of the present disclosure;

FIG. 7B illustrates a UI displaying application indications corresponding to applications configured to provide the selected service, and health information indications corresponding to pieces of health information used to provide the selected service in the selected application, according to various embodiments of the present disclosure;

FIG. 7C illustrates a UI displaying application indications corresponding to applications configured to provide the selected service, and health information indications corresponding to pieces of health information used to provide the selected service in a selected application, according to various embodiments of the present disclosure;

FIG. 8A illustrates a UI displaying at least one health information available in the selected service and application indications associated with service providers that are configured to provide the selected service by using health information selected from the at least one health information, according to various embodiments of the present disclosure;

FIG. 8B illustrates a UI in an example where second health information is selected in a UI in FIG. 8A, according to various embodiments of the present disclosure;

FIG. 8C illustrates a UI in an example where third health information is selected in a UI in FIG. 8B, according to various embodiments of the present disclosure;

FIG. 9A illustrates a UI for displaying data associated with first health information, second health information, and third health information, according to various embodiments of the present disclosure;

FIG. 9B illustrates a plurality of service indications displayed when one of multiple pieces of health data displayed in FIG. 9A is selected, according to various embodiments of the present disclosure;

FIG. 9C illustrates a UI for displaying an application indication corresponding to at least one service provider, which is displayed when one of a plurality of services displayed in FIG. 9B is selected, and health information indications corresponding to pieces of health information used for at least one service provider to provide the selected service, according to various embodiments of the present disclosure;

FIG. 10A illustrates a UI for displaying pieces of health data respectively corresponding to first health information, second health information, and third health information, according to various embodiments of the present disclosure;

FIG. 10B illustrates a UI displayed when one of multiple pieces of health data displayed in FIG. 10A is selected, according to various embodiments of the present disclosure;

FIG. 11A illustrates a UI for displaying health information indications corresponding to first health information, second health information, and third health information, according to various embodiments of the present disclosure;

FIG. 11B illustrates a UI for displaying an indication corresponding to a service displayed, for example, when one of multiple pieces of health information displayed in FIG. 11A is selected, a service provider, and health information available to provide the displayed service, according to various embodiments of the present disclosure;

FIG. 12A illustrates a UI for displaying an indication corresponding to a plurality of electronic devices connected with an electronic device, according to various embodiments of the present disclosure;

FIG. 12B illustrates a UI for displaying an indication corresponding to a service configured to be provided through an electronic device selected in FIG. 12A, a service provider, and health information, according to various embodiments of the present disclosure;

FIG. 13A illustrates a UI for displaying a plurality of electronic devices connected to an electronic device and indications corresponding to pieces of health information used in a service configured to be provided through each of the plurality of electronic devices, according to various embodiments of the present disclosure;

FIG. 13B illustrates a UI for displaying an indication corresponding to a service, which uses health information selected in FIG. 13A, and a service provider that provides the service, according to various embodiments of the present disclosure;

FIG. 14 illustrates a UI for displaying indications corresponding to pieces of health information that a service provider uses to provide a selected service, according to various embodiments of the present disclosure;

FIG. 15 illustrates a UI for determining health information, of which access permission is assigned to a service provider, and other pieces of information through a user input, according to various embodiments of the present disclosure;

FIG. 16 is a flowchart illustrating an operation, performed in an electronic device, of providing a service between an API of the electronic device and a service provider, according to various embodiments of the present disclosure;

FIG. 17 is a flowchart illustrating an operation, performed in an electronic device, performing a service provision between an API of the electronic device and a service provider, according to various embodiments of the present disclosure; and

FIG. 18 is a flowchart illustrating an operation, performed in an electronic device, of allowing an application access to health information, according to various embodiments of the present disclosure.

Throughout the drawings, it should be noted that like reference numbers are used to depict the same or similar elements, features, and structures.

### DETAILED DESCRIPTION

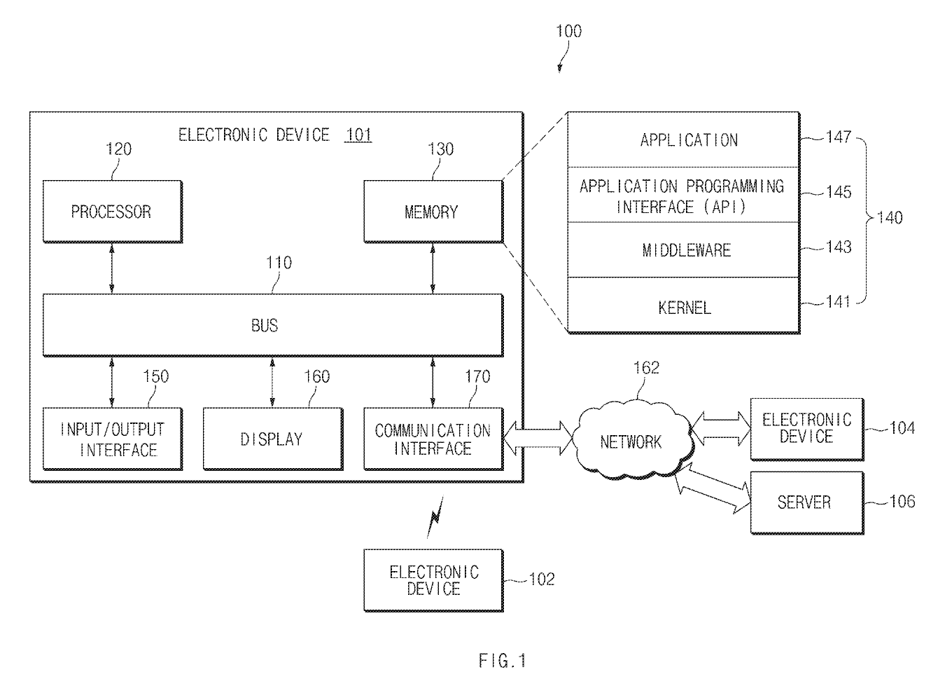

FIGS. 1 through 18, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device.

Various embodiments of the present disclosure may be described with reference to accompanying drawings. Accordingly, those of ordinary skill in the art will recognize that modification, equivalent, and/or alternative on the various embodiments described herein can be variously made without departing from the scope and spirit of the present disclosure. With regard to description of drawings, similar components may be marked by similar reference numerals.

In the disclosure disclosed herein, the expressions ‘have’, ‘may have’, ‘include’ and ‘comprise’, or ‘may include’ and ‘may comprise’ used herein indicate existence of corresponding features (e.g., elements such as numeric values, functions, operations, or components) but do not exclude presence of additional features.

In the disclosure disclosed herein, the expressions ‘A or B’, ‘at least one of A or/and B’, or ‘one or more of A or/and B’, and the like used herein may include any and all combinations of one or more of the associated listed items. For example, the term ‘A or B’, ‘at least one of A and B’, or ‘at least one of A or B’ may refer to all of the case (1) where at least one A is included, the case (2) where at least one B is included, or the case (3) where both of at least one A and at least one B are included.

The terms, such as ‘first’, ‘second’, and the like used herein may refer to various elements of various embodiments, but do not limit the elements. Furthermore, such terms may be used to distinguish one element from another element. For example, a first user device and a second user device indicate different user devices regardless of the order or priority. For example, without departing the scope of the present disclosure, a first element may be referred to as a second element, and similarly, a second element may be referred to as a first element.

It will be understood that when an element (e.g., a first element) is referred to as being “(operatively or communicatively) coupled with/to” or “connected to” another element (e.g., a second element), it may be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there are no intervening element (e.g., a third element).

According to the various embodiments of this disclosure, the expression ‘configured to’ as used herein may be used interchangeably with, for example, the expression ‘suitable for’, ‘having the capacity to’, ‘designed to’, ‘adapted to’, ‘made to’, or ‘capable of’. The term ‘configured to’ must not mean only ‘specifically designed to’ in hardware. Instead, the expression ‘a device configured to’ may mean that the device is ‘capable of’ operating together with another device or other components. CPU, for example, a ‘processor configured to perform A, B, and C’ may mean a dedicated processor (e.g., an embedded processor) for performing a corresponding operation or a generic-purpose processor (e.g., a central processing unit (CPU) or an application processor) which may perform corresponding operations by executing one or more software programs which are stored in a memory device.

Terms used in the present disclosure are used to describe specified embodiments and are not intended to limit the scope of the present disclosure. The terms of a singular form may include plural forms unless otherwise specified. Unless otherwise defined herein, all the terms used herein, which include technical or scientific terms, may have the same meaning that is generally understood by a person skilled in the art of the present disclosure. It will be further understood that terms, which are defined in a dictionary and commonly used, should also be interpreted as is customary in the relevant related art and not in an idealized or overly formal detect unless expressly so defined herein in various embodiments of the present disclosure. In some cases, even if terms are terms which are defined in the specification, they may not be interpreted to exclude embodiments of the present disclosure.

An electronic device according to various embodiments of the present disclosure may include at least one of smartphones, tablet personal computers (PCs), mobile phones, video telephones, e-book readers, desktop PCs, laptop PCs, netbook computers, workstations, servers, personal digital assistants (PDAs), portable multimedia players (PMPs), Motion Picture Experts Group (MPEG-1 or MPEG-2) Audio Layer 3 (MP3) players, mobile medical devices, cameras, wearable devices (e.g., head-mounted-devices (HMDs), such as electronic glasses), an electronic apparel, electronic bracelets, electronic necklaces, electronic appcessories, electronic tattoos, smart watches, and the like.

According to another embodiment, the electronic devices may be smart home appliances. The smart home appliances may include at least one of, for example, televisions (TVs), digital versatile disc (DVD) players, audios, refrigerators, air conditioners, cleaners, ovens, microwave ovens, washing machines, air cleaners, set-top boxes, home automation control panels, security control panels, TV boxes (e.g., Samsung HomeSync™, Apple TV™, or Google TV™), game consoles (e.g., Xbox™ or PlayStation™), electronic dictionaries, electronic keys, camcorders, electronic picture frames, or the like.

According to another embodiment, the electronic device may include at least one of medical devices (e.g., various portable medical measurement devices (e.g., a blood glucose monitoring device, a heartbeat measuring device, a blood pressure measuring device, a body temperature measuring device, and the like)), a magnetic resonance angiography (MRA), a magnetic resonance imaging (MRI), a computed tomography (CT), scanners, and ultrasonic devices), navigation devices, global positioning system (GPS) receivers, event data recorders (EDRs), flight data recorders (FDRs), vehicle infotainment devices, electronic equipment for vessels (e.g., navigation systems and gyrocompasses), avionics, security devices, head units for vehicles, industrial or home robots, automatic teller's machines (ATMs), points of sales (POSs), or internet of things (e.g., light bulbs, various sensors, electric or gas meters, sprinkler devices, fire alarms, thermostats, street lamps, toasters, exercise equipment, hot water tanks, heaters, boilers, and the like).

According to another embodiment, the electronic devices may include at least one of parts of furniture or buildings/structures, electronic boards, electronic signature receiving devices, projectors, or various measuring instruments (e.g., water meters, electricity meters, gas meters, or wave meters, and the like). According to various embodiments, the electronic device may be one of the above-described devices or a combination thereof. An electronic device according to an embodiment may be a flexible electronic device. Furthermore, an electronic device according to an embodiment of the present disclosure may not be limited to the above-described electronic devices and may include other electronic devices and new electronic devices according to the development of technologies.

Hereinafter, electronic devices according to various embodiments will be described with reference to the accompanying drawings. The term “user” used herein may refer to a person who uses an electronic device or may refer to a device (e.g., an artificial intelligence electronic device) that uses an electronic device.

Referring to FIG. 1, there is illustrated an electronic device 101 in a network environment 100 according to various embodiments. The electronic device 101 may include a bus 110, a processor 120, a memory 130, an input/output (I/O) interface 150, a display 160, and/or a communication interface 170. According to an embodiment, the electronic device 101 may not include at least one of the above-described elements or may further include other element(s).

For example, the bus 110 may interconnect the above-described elements 120 to 170 and may include a circuit for conveying communications (e.g., a control message and/or data) among the above-described elements.

The processor 120 may include one or more of a central processing unit (CPU), an application processor (AP), or a communication processor (CP). The processor 120 may perform, for example, data processing or an operation associated with control or communication of at least one other element(s) of the electronic device 101.

According to an embodiment, the processor 120 may provide a UI for determining whether to allow an application (e.g., an application 147) to access health information stored in an external device (e.g., an electronic device 102 or 104 and the server 106) connected with the memory 130 or an electronic device. For example, the processor 120 may display a service indication corresponding to a service (e.g., a workout management service) to be provided through the application (e.g., a health management application 385) on a display through the display circuit 160 together with a health information indication corresponding to the health information. According to an embodiment, the processor 120 may obtain a user input to the service indication displayed through the display circuit 160 through, for example, the I/O interface 150. According to an embodiment, the processor 120 may allow the application to access the health information based at least on the user input.

The memory 130 may include a volatile and/or nonvolatile memory. For example, the memory 130 may store instructions or data associated with at least one other element(s) of the electronic device 101. According to an embodiment, the memory 130 may store software and/or a program 140. The program 140 may include, for example, a kernel 141, a middleware 143, an application programming interface (API) 145, and/or an application program (or ‘application’) 147. At least a part of the kernel 141, the middleware 143, or the API 145 may be called an “operating system (OS)”.

The kernel 141 may control or manage system resources (e.g., the bus 110, the processor 120, the memory 130, and the like) that are used to execute operations or functions of other programs (e.g., the middleware 143, the API 145, and the application program 147). Furthermore, the kernel 141 may provide an interface that allows the middleware 143, the API 145, or the application program 147 to access discrete elements of the electronic device 101 so as to control or manage system resources.

The middleware 143 may perform, for example, a mediation role such that the API 145 or the application program 147 communicates with the kernel 141 to exchange data. Furthermore, with regard to task requests received from the application program 147, for example, the middle ware 143 may perform a control (e.g., scheduling or load balancing) on a task request by using a method of assigning the priority, which makes it possible to use a system resource (e.g., the bus 110, the processor 120, the memory 130, or the like) of the electronic device 101, to at least one application in the application program 147.

The API 145 may be an interface through which the application 147 controls a function provided by the kernel 141 or the middleware 143, and may include, for example, at least one interface or function (e.g., an instruction) for a file control, a window control, image processing, a character control, or the like.

The I/O interface 150 may transmit an instruction or data, input from a user or another external device, to other element(s) of the electronic device 101. Furthermore, the I/O interface 150 may output an instruction or data, received from other component(s) of the electronic device 101, to a user or another external device.

The display 160 may include, for example, a liquid crystal display (LCD), a light-emitting diode (LED) display, an organic LED (OLED) display, or a microelectromechanical systems (MEMS) display, or an electronic paper display. The display 160 may display, for example, various kinds of contents (e.g., a text, an image, a video, an icon, a symbol, and the like) to a user. The display 160 may include a touch screen and may receive, for example, a touch, gesture, proximity, or hovering input using an electronic pen or a portion of a user's body.

The communication interface 170 may establish communication between the electronic device 101 and an external electronic device (e.g., a first external electronic device 102, a second external electronic device 104, or a server 106). For example, the communication interface 170 may be connected to a network 162 through wireless communication or wired communication to communicate with an external device (e.g., the second external electronic device 104 or the server 106).

The wireless communication may include at least one of, for example, LTE, LTE-A, CDMA, WCDMA, UMTs, WiBro, GSM, or the like, as cellular communication protocol. The wired communication may include at least one of, for example, a universal serial bus (USB), a high definition multimedia interface (HDMI), a recommended standard 232 (RS-232), a plain old telephone service (POTS), or the like. The network 162 may include at least one of telecommunications networks, for example, a computer network (e.g., LAN or WAN), an Internet, or a telephone network.

Each of the first and second external electronic devices 102 and 104 may be a device of which the type is different from or the same as that of the electronic device 101. According to an embodiment, the server 106 may include a server or a group of two or more servers.

According to various embodiments, all or a part of operations that the electronic device 101 will perform may be executed by another or plural electronic devices (e.g., the electronic device 102 or 104 or the server 106). According to an embodiment, in the case where the electronic device 101 executes any function or service automatically or in response to a request, the electronic device 101 may not perform the function or the service internally, but, alternatively additionally, it may request at least a portion of a function associated with the electronic device 101 from other devices (e.g., the electronic device 102 or 104 or the server 106). The other electronic device (e.g., the electronic device 102 or 104 or the server 106) may execute the requested function or additional function and may transmit the execution result to the electronic device 101. The electronic device 101 may provide the requested function or service by processing the received result as it is, or additionally. To this end, for example, cloud computing, distributed computing, or client-server computing may be used.

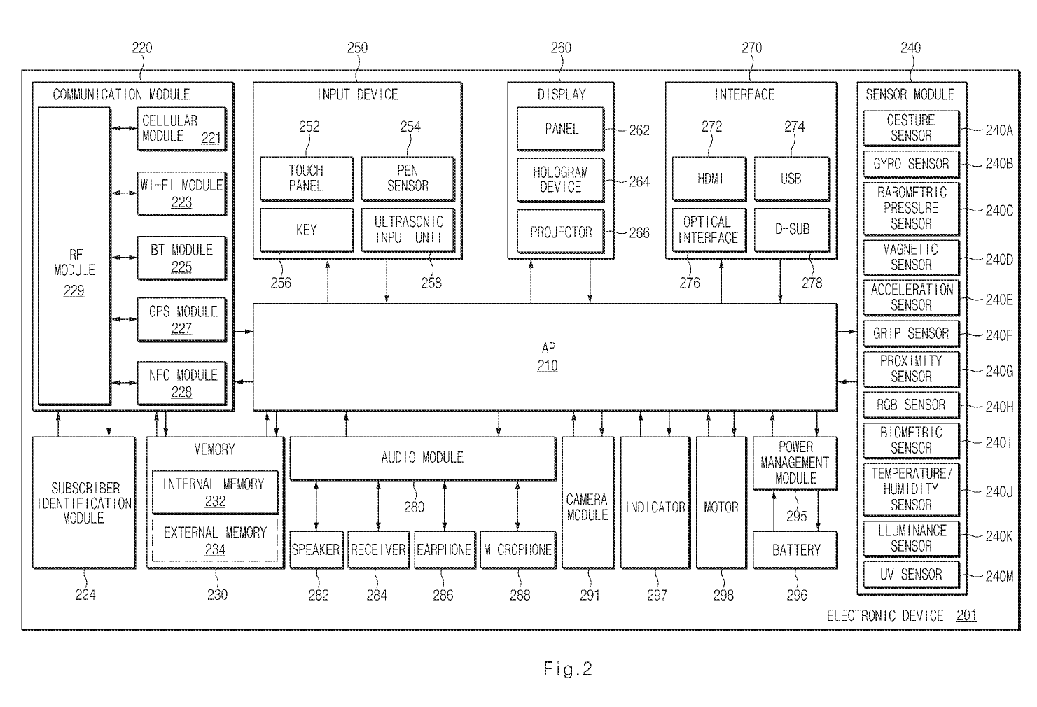

FIG. 2 is a block diagram 200 illustrating an electronic device 201, according to various embodiments. An electronic device 201 may include, for example, all or a part of an electronic device 101 illustrated in FIG. 1. The electronic device 201 may include one or more application processors (AP) 210, a communication module 220, a subscriber identification module (SIM) card 224, a memory 230, a sensor module 240, an input device 250, a display 260, an interface 270, an audio module 280, a camera module 291, a power management module 295, a battery 296, an indicator 297, and a motor 298.

The AP 210 may drive an operating system (OS) or an application program to control a plurality of hardware or software elements connected to the AP 210 and may process and compute a variety of data. The AP 210 may be implemented with a System on Chip (SoC), for example. According to an embodiment of the present disclosure, the AP 210 may further include a graphic processing unit (GPU) and/or an image signal processor. The AP 210 may include at least a part (e.g., a cellular module 221) of elements illustrated in FIG. 2. The AP 210 may load and process an instruction or data, which is received from at least one of other components (e.g., a nonvolatile memory), and may store a variety of data in a nonvolatile memory. According to an embodiment, the AP 210 may perform a function the same as or similar to that of the processor 120 illustrated in FIG. 1.

The communication module 220 may be configured the same as or similar to a communication interface 170 of FIG. 1. The communication module 220 may include a cellular module 221, a wireless-fidelity (Wi-Fi) module 223, a Bluetooth (BT) module 225, a global positioning system (GPS) module 227, a near field communication (NFC) module 228, and a radio frequency (RF) module 229.

The cellular module 221 may provide voice communication, video communication, a character service, an Internet service, or the like through a communication network. According to an embodiment of the present disclosure, the cellular module 221 may perform discrimination and authentication of an electronic device 201 within a communication network using a subscriber identification module (e.g., the SIM card 224), for example. According to an embodiment, the cellular module 221 may perform at least a portion of functions that the AP 210 provides. According to an embodiment, the cellular module 221 may include a communication processor (CP).

Each of the Wi-Fi module 223, the Bluetooth® (BT) module 225, the GPS module 227, and the NFC module 228 may include a processor for processing data exchanged through a corresponding module, for example. According to an embodiment, at least a part (e.g., two or more elements) of the cellular module 221, the Wi-Fi module 223, the BT module 225, the GPS module 227, or the NFC module 228 may be included within one Integrated Circuit (IC) or an IC package.

The RF module 229 may transmit and receive, for example, a communication signal (e.g., an RF signal). For example, the RF module 229 may include a transceiver, a power amplifier module (PAM), a frequency filter, a low noise amplifier (LNA), an antenna, or the like. According to another embodiment, at least one of the cellular module 221, the Wi-Fi module 223, the BT module 225, the GPS module 227, or the NFC module 228 may transmit and receive an RF signal through a separate RF module.

The SIM card 224 may include, for example, a card and/or embedded SIM that includes a subscriber identification module and may include unique identify information (e.g., integrated circuit card identifier (ICCID)) or subscriber information (e.g., integrated mobile subscriber identity (IMSI)).

The memory 230 (e.g., the memory 130 of FIG. 1) may include an internal memory 232 or an external memory 234. For example, the internal memory 232 may include at least one of a volatile memory (e.g., a dynamic random access memory (DRAM), a static RAM (SRAM), or a synchronous DRAM (SDRAM)), a nonvolatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a NAND flash memory, or a NOR flash memory), a hard drive, or a solid state drive (SSD).

The external memory 234 may further include a flash drive, for example, compact flash (CF), secure digital (SD), micro secure digital (Micro-SD), mini secure digital (Mini-SD), extreme digital (xD), a memory stick, or the like. The external memory 234 may be functionally and/or physically connected with the electronic device 201 through various interfaces.

The sensor module 240 may measure, for example, a physical quantity or may detect an operation state of the electronic device 201. The sensor module 240 may convert the measured or detected information to an electric signal. The sensor module 240 may include at least one of a gesture sensor 240A, a gyro sensor 240B, a pressure (e.g. barometric pressure) sensor 240C, a magnetic sensor 240D, an acceleration sensor 240E, a grip sensor 240F, a proximity sensor 240G, a color sensor 240H (e.g., red, green, blue (RGB) sensor), a living body/biometric sensor 2401, a temperature/humidity sensor 240J, an illuminance sensor 240K, or an UV sensor 240M. Additionally or alternatively, the sensor module 240 may include, for example, an E-nose sensor, an electromyography sensor (EMG) sensor, an electroencephalogram (EEG) sensor, an electrocardiogram (ECG) sensor, an infrared (IR) sensor, an iris sensor, and/or a fingerprint sensor. The sensor module 240 may further include a control circuit for controlling at least one or more sensors included therein. According to an embodiment, the electronic device 201 may further include a processor which is a part of the AP 210 or independent of the AP 210 and is configured to control the sensor module 240. The processor may control the sensor module 240 while the processor 2110 remains at a sleep state.

The input device 250 may include, for example, a touch panel 252, a (digital) pen sensor 254, a key 256, or an ultrasonic input unit 258. The touch panel 252 may use at least one of capacitive, resistive, infrared and ultrasonic detecting methods. Also, the touch panel 252 may further include a control circuit. The touch panel 252 may further include a tactile layer to provide a tactile reaction to a user.

The (digital) pen sensor 254 may be, for example, a part of a touch panel or may include an additional sheet for recognition. The key 256 may include, for example, a physical button, an optical key, a keypad, and the like. The ultrasonic input device 258, which is an input device for generating an ultrasonic signal, may enable the electronic device 300 to sense a sound wave through a microphone (e.g., a microphone 288) so as to identify data.

The display 260 (e.g., the display 160) may include a panel 262, a hologram device 264, or a projector 266. The panel 262 may be configured the same as or similar to the display 160 of FIG. 1. The panel 262 may be implemented to be flexible, transparent or wearable, for example. The panel 262 and the touch panel 252 may be integrated into a single module. The hologram device 264 may display a stereoscopic image in a space using a light interference phenomenon. The projector 266 may project light onto a screen so as to display an image. The screen may be arranged inside or outside the electronic device 201. According to an embodiment, the display 260 may further include a control circuit for controlling the panel 262, the hologram device 264, or the projector 266.

The interface 270 may include, for example, a high-definition multimedia interface (HDMI) 272, a universal serial bus (USB) 274, an optical interface 276, or a D-subminiature (D-sub) 278. The interface 270 may be included, for example, in the communication interface 170 illustrated in FIG. 1. Additionally or alternatively, the interface 270 may include, for example, a mobile high definition link (MHL) interface, a secure Digital (SD) card/multi-media card (MMC) interface, or an infrared data association (IrDA) standard interface.

The audio module 280 may convert a sound and an electric signal in dual directions. At least a part of the audio module 280 may be included, for example, in the I/O interface 150 illustrated in FIG. 1. The audio module 280 may process, for example, sound information that is input or output through a speaker 282, a receiver 284, an earphone 286, or a microphone 288.

The camera module 291 for shooting a still image or a video may include, for example, at least one image sensor (e.g., a front sensor or a rear sensor), a lens, an image signal processor (ISP), or a flash (e.g., an LED or a xenon lamp).

The power management module 295 may manage, for example, power of the electronic device 201. According to an embodiment, the power management module 295 may include a power management integrated circuit (PMIC), a charger IC, or a battery or fuel gauge. The PMIC may have a wired charging method and/or a wireless charging method. The wireless charging method may include, for example, a magnetic resonance method, a magnetic induction method or an electromagnetic method and may further include an additional circuit, for example, a coil loop, a resonant circuit, a rectifier, or the like. The battery gauge may measure, for example, a remaining capacity of the battery 296 and a voltage, current or temperature thereof while the battery is charged. The battery 296 may include, for example, a rechargeable battery or a solar battery.

The indicator 297 may display a specific state of the electronic device 201 or a part thereof (e.g., the AP 210), such as a booting state, a message state, a charging state, or the like. The motor 298 may convert an electrical signal into a mechanical vibration and may generate the following effects: vibration, haptic, and the like. Although not illustrated in FIG. 2, a processing device (e.g., a GPU) for supporting a mobile TV may be included in the electronic device 201. The processing device for supporting the mobile TV may process media data according to the standards of DMB, digital video broadcasting (DVB), MediaFlo®, or the like.

Each of the above-mentioned elements of an electronic device may be configured with one or more components, and the names of the elements may be changed according to the type of the electronic device. According to various embodiments, the electronic device may include at least one of the above-mentioned elements, and some elements may be omitted or other additional elements may be added. Furthermore, some of the elements of the electronic device according to various embodiments may be combined with each other so as to form one entity, so that the functions of the elements may be performed in the same manner as before the combination.

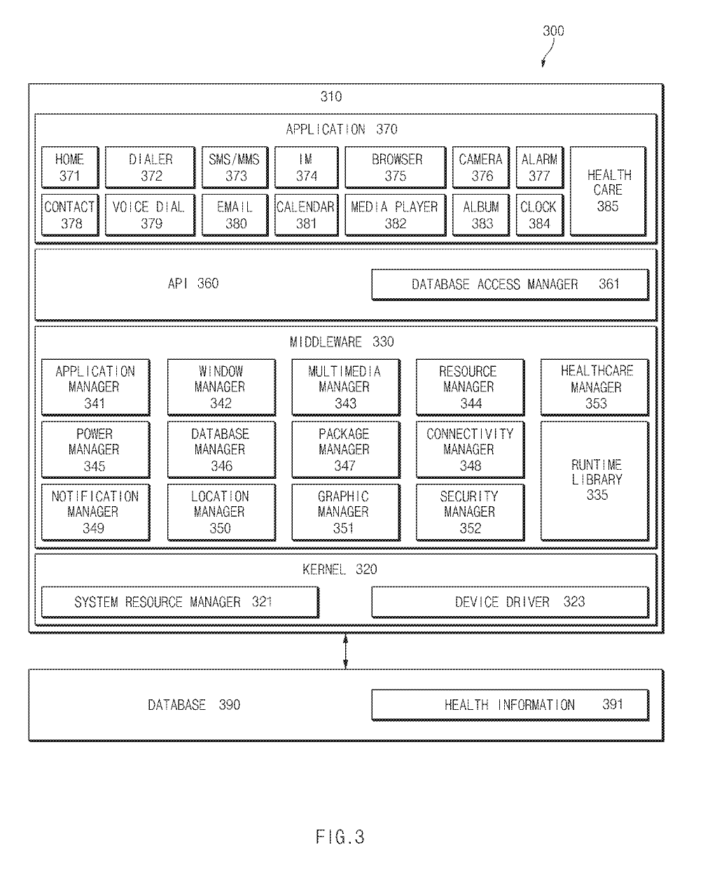

FIG. 3 is a block diagram 300 of a program module 310, according to various embodiments. According to an embodiment, the program module 310 (e.g., the program 140 of FIG. 1) may include an operating system (OS) to control resources associated with an electronic device (e.g., the electronic device 101) and/or diverse applications (e.g., the application program 147) driven on the OS. The OS may be, for example, Android®, iOS®, Windows®, Symbian®, Tizen®, or the like.

The program module 310 may include a kernel 320, a middleware 330, an application programming interface (API) 360, an application 370, and/or a database 390. At least a part of the program module 310 may be preloaded on an electronic device or may be downloadable from an external electronic device (e.g., the electronic device 102, the electronic device 104, the server 106, or the like).

The kernel 320 (e.g., the kernel 141) may include, for example, a system resource manager 321 and/or a device driver 323. The system resource manager 321 may perform control, allocation, or retrieval of system resources. According to various embodiments, the system resource manager 321 may include a process managing part, a memory managing part, a file system managing part, or the like. The device driver 323 may include, for example, a display driver, a camera driver, a Bluetooth driver, a common memory driver, an USB driver, a keypad driver, a Wi-Fi driver, an audio driver, or an inter-process communication (IPC) driver.

The middleware 330 may provide, for example, a function which the application 370 needs in common or may provide diverse functions to the application 370 through the API 360 to allow the application 370 to efficiently use limited system resources of the electronic device. According to various embodiments, the middleware 330 (e.g., the middleware 143) may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, or a security manager 352, or a healthcare manager 353.

The runtime library 335 may include, for example, a library module, which is used by a compiler, to add a new function through a programming language while the application 370 is being executed. The runtime library 335 may perform input/output management, memory management, capacities about arithmetic functions, or the like.

The application manager 341 may manage, for example, a life cycle of at least one application of the application 370. The window manager 342 may manage a GUI resource which is used in a screen. The multimedia manager 343 may identify a format necessary to play diverse media files, and may perform encoding or decoding of media files by using a codec suitable for the format. The resource manager 344 may manage resources such as a storage space, memory, or source code of at least one application of the application 370.

The power manager 345 may operate, for example, with a basic input/output system (BIOS) to manage a battery or power, and may provide power information for an operation of an electronic device. The database manager 346 may generate, search for, or modify database to be used in at least one application of the application 370. For example, in the case where at least one application (e.g., a health management application 385) of the application 370 requests (e.g., requests to modify, to input, to store, and to obtain health information 391) health information 391, the database manager 346 may search for the health information 391 through the database 390. The package manager 347 may install or update an application which is distributed in the form of a package file.

The connectivity manager 348 may manage, for example, wireless connection such as Wi-Fi or Bluetooth®. The notification manager 349 may display or notify an event such as an arrival message, an appointment, or a proximity notification in a mode that does not disturb a user. The location manager 350 may manage location information of an electronic device. The graphic manager 351 may manage a graphic effect to be provided to a user or a user interface relevant thereto. The security manager 352 may provide a general security function necessary for system security, user authentication, or the like. The health management manager 353 may manage permission to access the health information 391. For example, the health management manager 353 may assign or cancel the permission to access the health information 391 to at least a part (e.g., the health management application) of the application 370. According to various embodiments, in the case where an electronic device (e.g., the electronic device 101) includes a telephony function, the middleware 330 may further includes a telephony manager for managing a voice or video call function of the electronic device.

The middleware 330 may include a middleware module that combines diverse functions of the above-described elements. The middleware 330 may provide a module specialized to each OS kind to provide differentiated functions. In addition, the middleware 330 may remove a part of the preexisting elements, dynamically, or may add new elements thereto.

The API 360 (e.g., the API 145) may be, for example, a set of programming functions and may be provided with a configuration which is variable depending on an OS. For example, in the case where an OS is the android or the iOS™, it may be permissible to provide one API set per platform. In the case where an OS is the Tizen™, it may be permissible to provide two or more API sets per platform.

The API 360 may include a database access manager 361. In the case where at least one application (e.g., the health management application 385) of the application 370 requests to access the health information 391, the database access manager 361 may allow or reject to access the health information 391. In addition, in the case where at least one application (e.g., the health management application 385) requests to access (obtain) the health information 391, the at least one application may request the health information 391 from the database manager 345.

The application 370 (e.g., the application program 147) may include, for example, one or more applications capable of providing functions for a home 371, a dialer 372, an SMS/MMS 373, an instant message (IM) 374, a browser 375, a camera 376, an alarm 377, a contact 378, a voice dial 379, an e-mail 380, a calendar 381, a media player 382, an album 383, or a clock 384, or for offering a health care 385 (e.g., measuring an exercise quantity, blood glucose, or the like), environment information (e.g., information of barometric pressure, humidity, or temperature), or the like.

According to various embodiments, the application 370 may include an application (hereinafter referred to as “information exchanging application” for descriptive convenience) to support information exchange between the electronic device (e.g., the electronic device 101) and an external electronic device (e.g., the electronic device 102 or 104). The information exchanging application may include, for example, a notification relay application for transmitting specific information to the external electronic device, or a device management application for managing the external electronic device.

For example, the notification relay application may include a function of transmitting notification information, which arise from other applications (e.g., applications for SMS/MMS, e-mail, health care, or environmental information), to an external electronic device (e.g., the electronic device 102 or 104). Additionally, the information exchanging application may receive, for example, notification information from an external electronic device and provide the notification information to a user.

The device management application may manage (e.g., install, delete, or update), for example, at least one function (e.g., turn-on/turn-off of an external electronic device itself (or a part of components) or adjustment of brightness (or resolution) of a display) of the external electronic device (e.g., the electronic device 102 or 104) which communicates with the electronic device, an application running in the external electronic device, or a service (e.g., a call service, a message service, or the like) provided from the external electronic device.

According to various embodiments, the application 370 may include an application (e.g., a health care application) which is assigned in accordance with an attribute (e.g., an attribute of a mobile medical device as a kind of electronic device) of an external electronic device (e.g., the electronic device 102 or 104). According to various embodiments, the application 370 may include an application received from an external electronic device (e.g., the server 106 or the electronic device 102 or 104). According to various embodiments, the application 370 may include a preloaded application or a third party application which is downloadable from a server. The component titles of the program module 310 according to the embodiment may be modifiable depending on kinds of operating systems.

The database 390 may include the health information 391 and may send the health information 391 to the health care application 385 based on a request of the database manager 346.

According to various embodiments, at least a part of the program module 310 may be implemented by software, firmware, hardware, or a combination of two or more thereof. At least a portion of the program module 310 may be implemented (e.g., executed), for example, by the processor (e.g., the processor 210). At least a portion of the program module 310 may include, for example, modules, programs, routines, sets of instructions, or processes, or the like for performing one or more functions.

According to various embodiments, the program module 310 may display a service indication corresponding to a service, which the health management application 385 provides, and a health information indication corresponding to the relevant health information 391. In the case where the program module 310 recognizes input acquisition of the service indication, the health management application 385 may request permission to access the health information 391 from a database access manager 361 as a response to the input.

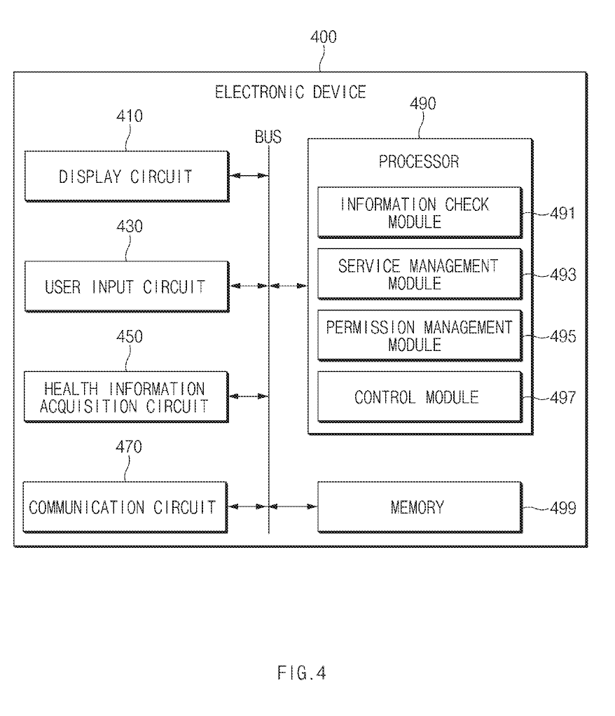

FIG. 4 is a block diagram of an electronic device configured to provide a health management UI, according to various embodiments of the present disclosure.

Referring to FIG. 4, the electronic device 400 (e.g., the electronic device 101 or 201) may include a display circuit 410, a user input circuit 430, a health information acquisition circuit 450, a communication circuit 470, a processor 490, and a memory 499. A configuration of the electronic device 400 illustrated in FIG. 4 may be only exemplary and may be variously changed or modified. For example, the electronic device 400 may further include a user interface for receiving any instruction or information from a user. The user interface may be an input device such as a keyboard, a mouse, or the like, or the user interface may also be a graphical user interface (GUI) to be displayed in a screen of the electronic device 400.

The user input circuit 430 may process a variety of inputs or information received from the outside. The user input circuit 430 may include a touch integrated circuit (IC). For example, the user input circuit 430 may process a user input that is input from the user. The user input may be a touch input using a finger or a stylus (e.g., an electronic pen) of the user. Also, the user input may include an input for providing an input through an electric change although a finger or a stylus of the user is not in direct contact with the screen, for example a hover input.

The user input circuit 430 may distinguish and process various types of the touch input. A type of the touch input may include, for example, a touch down, a touch drag (or a touch move), a touch release, a touch hold (or a long press), a drag and drop, or the like.

According to various embodiments of the present disclosure, the health information acquisition circuit 450 may include a sensor hub. The health information acquisition circuit 450 may obtain health information of the user received by using various sensors (e.g., at least one or more sensors included in the sensor module 240 of FIG. 2) included in the electronic device 400. For example, the health information acquisition circuit 450 may obtain a heart rate of the user received through a biometric sensor (e.g., the biometric sensor 240I of FIG. 2) (e.g., a heartbeat sensor). In addition, the health information acquisition circuit 450 may obtain a blood temperature of the user received through a temperature/humidity sensor (e.g., the temperature/humidity sensor 240J of FIG. 2). Furthermore, the health information acquisition circuit 450 may obtain the number of steps of the user, which is received through a pedometer. Also, the health information acquisition circuit 450 may obtain a complexion, behavior, or the like of the user received through an image sensor, a motion sensor, or the like.

According to various embodiments of the present disclosure, the communication circuit 470 may receive the health information of the user from the outside. The communication circuit 470 (e.g., the communication circuit 220 or the interface 270 of FIG. 2) may use a wired network as well as a wireless network. For example, the communication circuit 470 may be an example of an external electronic device (e.g., the electronic device 102 or 104 of FIG. 1), for example, a wearable device and may receive the health information of the user from a smart watch, a blood pressure cuff or a heartbeat measuring device which has a communication function, or the like. Alternatively, the communication circuit 470 may receive the health information of the user from an external server (e.g., the server 106 of FIG. 1), for example, a server that a hospital operates.

The health information may include information, for example, a gender, a blood type, a height, a weight, a medical history, a heart rate, a blood temperature, blood glucose, a workout time, a sleep time, a sleep pattern, carbohydrate intake, water intake, or the like of the user. As described above, the health information may be obtained through, for example, the health information acquisition circuit 450 or may be obtained by being received from an external through the communication circuit 470. Alternatively, the health information may be directly input from the user through, for example, the user input circuit 430.

The processor 490 (e.g., the processor 120 of FIG. 1, the processor 210 of FIG. 2) may be implemented with, for example, a system on chip (SoC). The processor 403 may include one or more of, for example, a central processing unit (CPU), a graphic processing unit (GPU), an image signal processor, an application processor (AP), and a communication processor (CP). The processor 490 may load an instruction or data, which is received from at least one of other elements (e.g., the display circuit 410, the user input circuit 430, the health information acquisition circuit 450, and the communication circuit 470), from the memory 499, may process the instruction or the data, and may store various pieces of data in the memory 499.

According to various embodiments of the present disclosure, the processor 490 may include an information check module 491, a service management module 493, a permission management module 495, and a control module 497.

According to an embodiment, the information check module 491 may verify service provider information, which is obtained from a service provider (e.g., an application), an external device (e.g., a server of an application vendor (Google play® or App store®)), or a memory included in the electronic device, service information, or the health information that is necessary to provide a service.

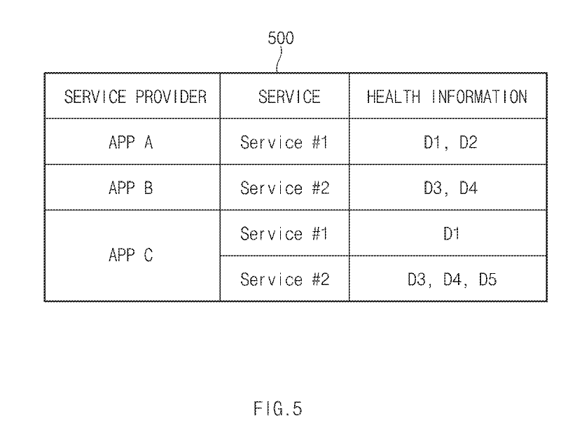

According to an embodiment, like information (e.g., an application ID) about the service provider, the service management module 493 may manage the health information verified through the information check module 491 in connection with the service information. The embodiment in which the service management module 493 manages the health information in connection with the service information will be described with reference to FIG. 5.

According to an embodiment, the information check module 491 may search for a service provider, which is capable of providing a service, from the memory 499 included in the electronic device. Alternatively, the information check module 491 may verify the service provider, which is capable of providing the service, through the external device (e.g., the server of the application vendor (Google play® or App store®)). In each case, the service management module 493 may manage the verified service provider in connection with a corresponding service. For example, in the case where an application that is capable of providing a ‘Sleep analysis’ service is not installed in the electronic device 400, the information check module 491 may search for the application that is capable of providing the ‘Sleep analysis’ service through an external server. The service management module 493 may manage the found application in connection with the service.

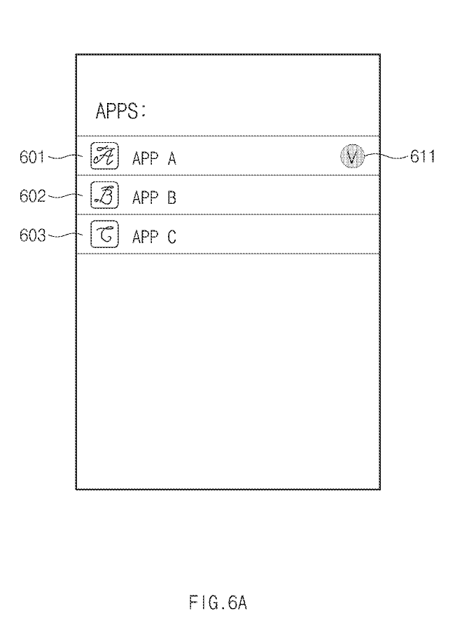

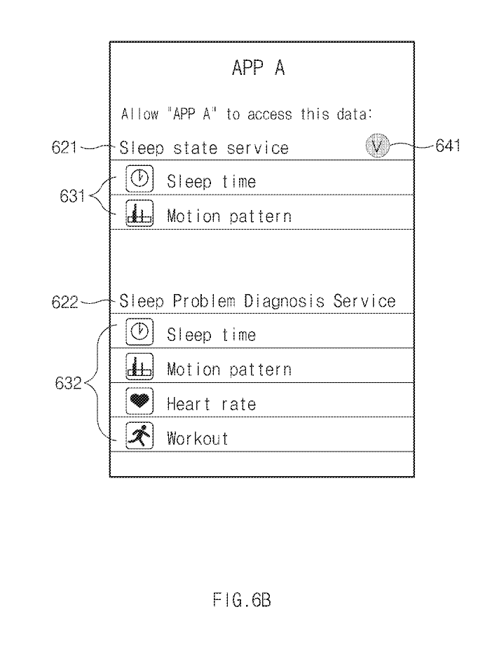

According to an embodiment, the service management module 493 may connect with at least two or more of the service provider information, the service information, and the health information and may provide the at least two or more of the service provider information, the service information, and the health information through the display circuit 410. A detailed description thereof will be described with reference to FIG. 6.

According to an embodiment, the permission management module 495 may assign permission to the service provider based on a user input, which is received through the user input circuit 430, such that the service provider accesses the health information, which is necessary to provide the service, (e.g., service provider records or obtains the health information) or provides (or updates) the health information that is necessary to provide the service. For example, referring to a table 500 of FIG. 5, the permission management module 495 may assign the permission to ‘application A’ based on the user input such that ‘application A’ that provides service #1 accesses pieces of health information D1 and D2 obtained through the health information acquisition circuit 450. In the case where ‘application A’ requests the pieces of health information D1 and D2, the control module 497 may send the pieces of health information D1 and D2 to ‘application A’. On the other hand, in the case where ‘application A’ requests health information D3 instead of the pieces of health information D1 and D2, the control module 497 may not send the health information D3 to ‘application A’.

In addition, the permission management module 495 may assign the permission to ‘application B’ based on the user input so as to update pieces of health information D3 and D4. Accordingly, the control module 497 may receive the pieces of health information D3 and D4 that ‘application B’ updates. On the other hand, in the case where ‘application B’ attempts to update health information D5 instead of the pieces of health information D3 and D4, the control module 497 may request ‘application B’ or another external device associated with ‘application B’ not to update the health information D5.

The memory 499 (e.g., the memory 130 of FIG. 1 or the memory 230 of FIG. 2) may store data, for example, instructions for operations performed in the processor 490. In this case, data stored in the memory 499 may include data exchanged between internal elements of the electronic device 400 and data exchanged between the electronic device 400 and external elements thereof.

According to various embodiments of the present disclosure, in the memory 499, a memory, in which the health information is stored, and a memory in which the application is stored may be separated. Accordingly, as described above, permission to access the corresponding health information may be required for the application to access the health information. In addition, the permission to access the corresponding health information may be required to store the health information, which is measured or calculated through the application, in the memory 499.

For example, the memory, in which the health information is stored, and the memory in which the application is stored may be physically separated or may be separated in the software manner.

It should be well understood to those skilled in the art that the display circuit 410, the user input circuit 430, the health information acquisition circuit 450, the communication circuit 470, the processor 490, and the memory 499 are implemented independently of each other or two or more thereof are integrated.

FIG. 5 is a drawing illustrating a table that a service management module manages, according to various embodiments of the present disclosure.

According to an embodiment, the service management module 493 may manage a service provider (an application), a service, and health information by using a table 500. According to an embodiment, the service management module 493 may determine at least one or more services that are capable of being provided through the electronic device 400. Accordingly, the service management module 493 may verify service provider information through the information check module 491 and may select a service, which corresponds to the service provider information, from among the at least one or more services based on the verified result. In this case, the service management module 493 may manage the selected service in connection with the service provider information.

According to an embodiment, the service management module 493 may determine at least one health information item that each service provides. Accordingly, the service management module 493 may verify service information through the information check module 491 and may select the health information, which corresponds to the service information, from among the at least one health information. In this case, the service management module 493 may manage the selected health information in connection with the service.

According to an embodiment, the necessary health information may vary according to the service provider in spite of the same service. Referring to the table 500, application ‘A’ may need pieces of health information D1 and D2 through service #1. On the other hand, application ‘C’ may need only the health information D1 through service #1. In addition, application ‘B’ may need pieces of health information D3 and D4 through service #2. On the other hand, application ‘C’ may need health information D5 as well as pieces of health information D3 and D4 through service #2.

Accordingly, according to an embodiment, the service management module 493 may manage the service provider (an application), the service, and the health information by using the table 500. The service management module 493 may manage lists by connecting the lists with each other.

FIG. 6A illustrates a UI displaying (e.g., arranging) a list of service providers associated with services that an electronic device is capable of providing, according to various embodiments of the present disclosure.

Referring to FIG. 6A, the electronic device 400 may provide, through the display circuit 410, a UI for displaying (e.g., arranging) a first application indication 601 corresponding to a first service provider (e.g., an application), a second application indication 602 corresponding to a second service provider, and a third application indication 603 corresponding to a third service provider. The first application indication 601 may include, for example, an icon, a name, an image, a video, or a text, which corresponds to the first service provider. The second application indication 602 may include, for example, an icon, a name, an image, a video, or a text, which corresponds to the second service provider. In addition, the third application indication 603 may include, for example, an icon, a name, an image, a video, or a text, which corresponds to the third service provider.

Each of the first service provider (e.g., application ‘A’), the second service provider (e.g., application ‘B’), and the third service provider (e.g., application ‘C’) may be an application that is installed in, for example, the memory 499. For example, at least one of the first service provider, the second service provider, and the third service provider may be a health management application. Also, each of the first service provider, the second service provider, and the third service provider may be a health management application that is installed in, for example, the memory 499.

The electronic device 400 may receive, through the user input circuit 430, a user input 611, for example, a touch input, a force touch input, or a hover input, to one of the first application indication 601, the second application indication 602, and the third application indication 603. Below, in FIG. 6B, it will be exemplified that the electronic device 400 receives the user input 611 for selecting the first application indication 601 through the user input circuit 430.

FIG. 6B illustrates a UI for displaying (e.g., arranging) service indications 621 and 622 corresponding to services, which the selected service provider (e.g., an application) is capable of providing, and health information indications 631 and 632 corresponding to pieces of health information used in each of services, according to various embodiments of the present disclosure.

According to an embodiment, FIG. 6B illustrates a UI displayed in response to the user input 611 for selecting the first application indication 601 in FIG. 6A. Referring to FIG. 6B, a first service provider (e.g., application ‘A’) may provide a first service (e.g., a sleep state service) and a second service (e.g., a sleep problem diagnosis service). Accordingly, the first service indication 621 corresponding to the first service and the second service indication 622 corresponding to the second service may be displayed in the electronic device 400. The first service indication 621 may include, for example, an icon, a name, an image, a video, or a text, which corresponds to the first service. In addition, the second service indication 622 may include, for example, an icon, a name, an image, a video, or a text, which corresponds to the second service.

According to an embodiment, the first service provider may provide only the first and second services. However, according to another embodiment, the first service provider may provide a lot of services in addition to the first and second services. Moreover, the electronic device 400 may further display a service indication corresponding to another service, which does not appear, through a user input (e.g., an input for scrolling up and down or left and right) on the UI illustrated in FIG. 6B.

For example, the first service may include information about a sleep time and a motion pattern during sleep as health information (e.g., minimum health information that is necessary to provide the first service) to be used. Accordingly, a first health information indication 631 corresponding to the information about the sleep time and the motion pattern during sleep may be displayed in an area (e.g., an upper area, a lower area, a right area, or a left area of an area in which the first service indication 621 is displayed) that is adjacent to an area in which the first service indication 621 corresponding to the first service is displayed. The first health information indication 631 may include, for example, an icon, a name, an image, a video, a text, or measurement data which corresponds to the first health information.

In addition, the second service indication 622 may include information about a sleep time and a motion pattern during sleep, a heart rate, and a workout as health information (e.g., minimum health information that is necessary to provide the second service) to be used. Accordingly, the second health information indication 632 corresponding to the information about the sleep time, the motion pattern during sleep, a heart rate, and a workout may be displayed in an area (e.g., an upper area, a lower area, a right area, or a left area of an area in which the second service indication 622 is displayed) that is adjacent to an area in which the second service indication 622 corresponding to the second service is displayed. The second health information indication 632 may include, for example, an icon, a name, an image, a video, a text, or measurement data which corresponds to the second health information.

As illustrated in FIG. 6B, the health information indication corresponding to the health information, which is used for a service provider (e.g., an application) to provide a service, may be displayed in connection with a service indication corresponding to the corresponding service.

According to an embodiment, the electronic device 400 may assign permission to access the sleep time and the motion pattern during sleep to application ‘A’ based on a user input 641 for selecting the first service indication 621. According to an embodiment, the electronic device 400 may assign permission to access the sleep time to application ‘A’ based on a user input corresponding to an indication, which corresponds to the sleep time, in the first health information indication. Furthermore, the electronic device 400 may assign permission to access the motion pattern to application ‘A’ based on a user input corresponding to an indication, which corresponds to the motion pattern, in the first health information indication.

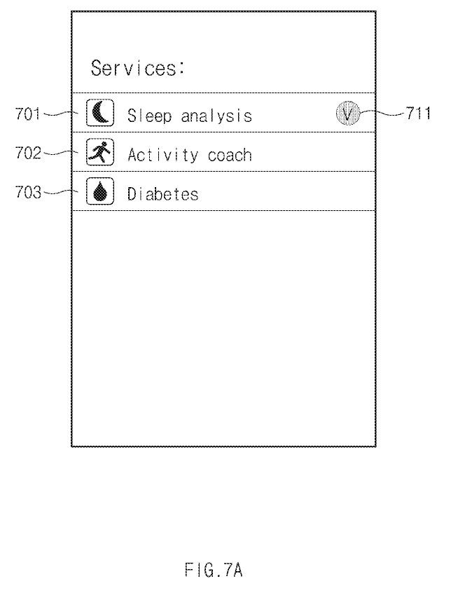

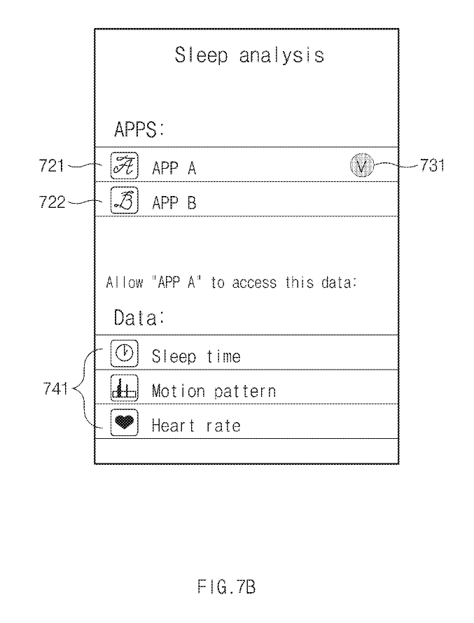

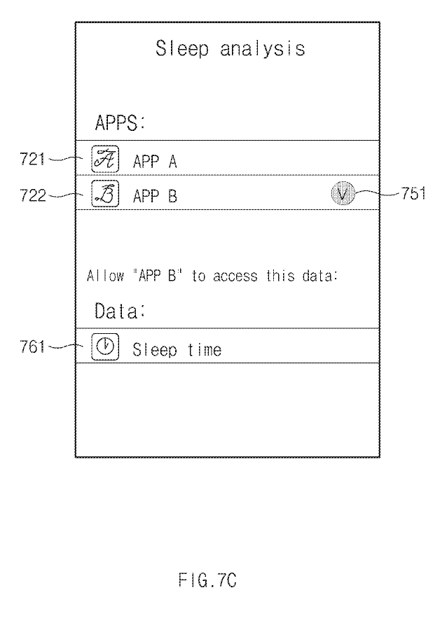

FIG. 7A illustrates a UI displaying (e.g., arranging) a list of services that an electronic device is capable of providing, according to various embodiments of the present disclosure.

Referring to FIG. 7A, the electronic device 400 may provide a UI for displaying (e.g., arranging) a first service indication 701 corresponding to a first service, a second service indication 702 corresponding to a second service, and a third service indication 703 corresponding to a third service through the display circuit 410.

Each of the first service (e.g., a sleep analysis service), the second service (e.g., an activity coach service), and the third service (e.g., a diabetes service) may be a service that is capable of being provided through, for example, at least one application installed in the memory 499. For example, one application may provide only one service or may provide a plurality of services. Also, two or more applications may provide the same service. As described above, health information that each of the services uses may vary for each application.

The electronic device 400 may receive a user input 711, for example, a touch input, a force touch input, or a hover input, to one of the first service indication 701, the second service indication 702, and the third service indication 703 through the user input circuit 430. Below, in FIG. 7B, it will be exemplified that the electronic device 400 receives a user input for selecting the first service indication 701 through the user input circuit 430.

FIG. 7B illustrates a UI displaying (e.g., arranging) an application indications corresponding to applications, which are capable of providing the selected service, and health information indications corresponding to pieces of health information used to provide the selected service in the selected application, according to various embodiments of the present disclosure.

FIG. 7B illustrates a UI displayed as a response to the user input 711 for selecting the first service indication 701 in FIG. 7A. Referring to FIG. 7B, a first service may be provided by a first service provider (e.g., application ‘A’) and a second service provider (e.g., application ‘B’). Accordingly, a first application indication 721 corresponding to the first service provider and a second service indication 722 corresponding to the second service provider may be displayed as a response to the user input 711 for selecting the first service indication 701. For example, although not illustrated in FIG. 7B, the first application indication 721 and the second application indication 722 may be displayed in an area (e.g., a top area, a bottom area, a right area, or a left area of an area in which the first service indication 701 is displayed) that is adjacent to an area in which the first service indication 701 corresponding to the first service is displayed.

According to an embodiment, an application, which is stored in the memory 499, from among applications that provide the first service may be provided by only the first and second service providers. However, according to another embodiment, a plurality of applications that provide the first service may be registered in an application store (e.g., App store™, Google play™, or the like). In this case, an application indication corresponding to a service provider registered in the application store may be displayed (e.g., arranged) in the UI illustrated in FIG. 7B.

According to an embodiment, the electronic device 400 may receive a user input 731 for selecting the first application indication 721 through the user input circuit 430. The electronic device 400 may display at least one health information indication 741 corresponding to at least one health information (e.g., minimum health information that is necessary to provide the first service) that is used for the first service provider 721 to provide the first service, through the display circuit 410 as a response to the user input 731. For example, the health information may include sleep time information, motion pattern information, and heart rate information.

According to an embodiment, on the basis of the user input 731 to the first application indication, the electronic device 400 may allow the first service provider to access the health information. According to an embodiment, on the basis of a user input for selecting the health information indication 741, the electronic device 400 may allow the first service provider to access the health information. The user input for selecting the health information indication 741 may be selection of one of a first health information indication (e.g., an indication corresponding to the sleep time information), a second health information indication (e.g., an indication corresponding to the motion pattern information), and a third health information indication (e.g., an indication corresponding to the heart rate information), which are included in the health information indication 741.

FIG. 7C is a drawing illustrating a UI arranging application indications corresponding to applications, which are capable of providing the selected service, and health information indications corresponding to pieces of health information used to provide the selected service in the selected application, according to various embodiments of the present disclosure.

In FIG. 7A, an operation, in which an application indication corresponding to an application that is capable of providing the selected service is provided, is the same as that in FIG. 7B, and thus a description thereof may not be repeated here.

The electronic device 400 may receive a user input 751 for selecting the second application indication 722 through the user input circuit 430 while the first application indication 721 and the second application indication 722 are displayed. The electronic device 400 may display at least one health information indication 761 corresponding to at least one health information item used for the second service provider to provide the first service, through the display circuit 410 as a response to the user input 751. For example, the health information may be sleep time information.

According to an embodiment, the electronic device 400 may allow the second service provider to access the health information based on the user input 751 for selecting the second application indication 722. According to an embodiment, on the basis of a user input for selecting the health information indication 761, the electronic device 400 may allow the second service provider to access the health information.

According to an embodiment, in FIG. 7B and FIG. 7C, it is understood that even though the same service is selected (refer to FIG. 7A), a health information indication corresponding to health information to be used is differently displayed as the selected service provider is changed.

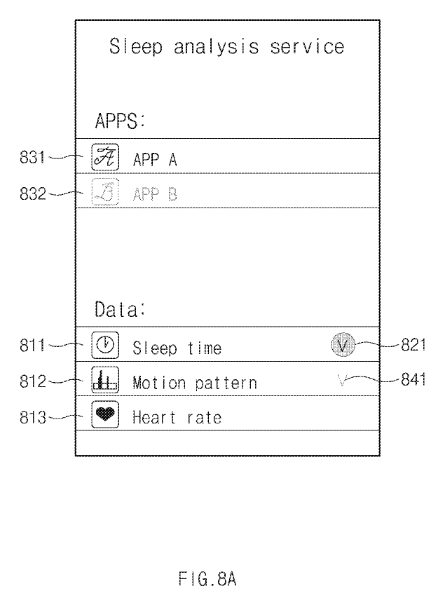

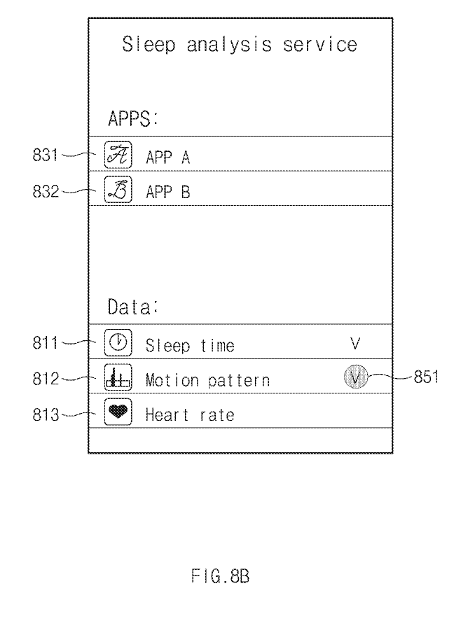

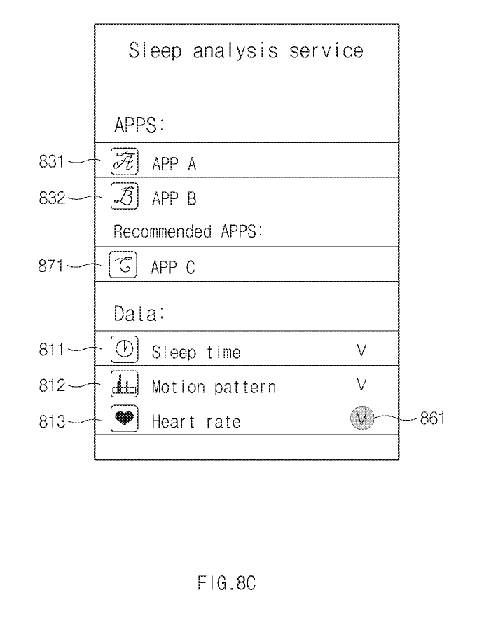

FIG. 8A illustrates a UI arranging at least one health information available in the selected service and application indications associated with service providers (e.g., an application) that are capable of providing the selected service by using health information selected from the at least one health information, according to various embodiments of the present disclosure.

FIG. 8A may be a UI screen of a sleep analysis service that is selected through, for example, a user input. The selected sleep analysis service may include first health information (e.g., sleep time health information), second health information (e.g., motion pattern health information), and third health information (e.g., heart rate health information) as available health information. Accordingly, a first health information indication 811 corresponding to the first health information, a second health information indication 812 corresponding to the second health information, and a third health information indication 813 corresponding to the third health information may be displayed in the UI screen of the sleep analysis service.

FIG. 8A may be a UI, for example, when the first health information 811 is selected through a user input 821 to the first health information indication 811. In this case, the electronic device 400 may display a first application indication 831 corresponding to a first service provider (e.g., application ‘A’) and a second application indication 832 corresponding to a second service provider (e.g., application ‘B’) based on the user input 821 for selecting the first health information indication 811.

According to an embodiment, the first application indication 831 and the second application indication 832 may be displayed in different manners. For example, the first service provider may make use of only the first health information, and the second service provider may further make use of the first health information and other health information (e.g., the second health information and the third health information). In this case, referring to FIG. 8A, the first application indication 831 may be displayed in a first display manner (e.g., in a solid line), and the second application indication 832 may be displayed in a second display manner (e.g., in a dotted line or blurredly).

For example, the second service provider may provide the sleep analysis service by using the first health information and the second health information. Accordingly, in the case where the first health information indication 811 is selected, the second application indication 832 may be displayed in the dotted line or blurredly. For example, an indicator 841 may be substantially simultaneously displayed in the second health information indication 812 in the dotted line or blurredly. Since the third health information is not used when the second service provider (e.g., application ‘B’) provides the sleep analysis service, a separate indicator associated with the third health information indication 813 may not be displayed.

According to various embodiments of the present disclosure, another service provider that provides the sleep analysis service by using only the second health information and the third health information may be stored in the memory 499.

In the case where the first application indication 831 is selected, the electronic device 400 may assign permission to access the first health information to the first service provider.

FIG. 8B illustrates a UI in an example where second health information is selected in a UI of FIG. 8A, according to various embodiments of the present disclosure.

Referring to FIG. 8B, the second health information corresponding to the indicator 832 that is displayed in a dotted line or blurredly in the UI illustrated in FIG. 8A may be selected through a user input 851. In this case, the electronic device 400 may change a way to display the second application indication 832 that provides a sleep analysis service, by using the first health information and the second health information (e.g., changes the way to display such that the blurredly displayed second application indication 832 becomes clear) and may display the application indication 832 by using the changed display way. A second service provider may be an application that fails to provide the sleep analysis service by using only one of, for example, the first health information or the second health information.

In the case where the second application indication 832 is selected, the electronic device 400 may assign permission to access the first health information and the second health information to the second service provider.

According to various embodiments of the present disclosure, the electronic device 400 may sort the orders of the first application indication 831 and the second application indication 832 based on priorities thereof (e.g., each frequency of use). For example, in the case where the first service provider is used more frequently than the second service provider, the electronic device 400 may display the first application indication 831 corresponding to the first service provider so as to be placed in an area above the second application indication 832 corresponding to the second service provider. Furthermore, for example, in the case where both the first health information indication 811 and the second health information indication 812 are selected, the electronic device 400 may display the second application indication 832 corresponding to the second service provider that uses both the first health information and the second health information, so as to be placed in an area above the first application indication 831 corresponding to the first service provider that uses only the first health information.

FIG. 8C is a drawing illustrating a UI in the case where third health information is selected in a UI in FIG. 8B, according to various embodiments of the present disclosure.

Referring to FIG. 8C, the third health information indication 813 may be selected through a user input 861 in the UI illustrated in FIG. 8B. In this case, the electronic device 400 may display (e.g., clearly display) a third application indication 871 corresponding to a third service provider, which provides a sleep analysis service, by using third health information together with the first application indication 831 corresponding to a first service provider, which is previously selected, and the second application indication 832 corresponding to a second service provider.

According to an embodiment, at least one of the first to third application indications 831, 832, and 871 may be displayed to be distinguished from the remaining application indications. For example, as illustrated in FIG. 8C, the third service provider may not be an application stored in the memory 499. Accordingly, the UI of FIG. 8C may display the third application indication 871 corresponding to the third service provider as a recommended application, with the third application indication 871 separated from the first and second application indications 831 and 832. If the third service provider is an application stored in the memory 499, the third application indication 871 may be displayed together with the first application indication 831 and the second application indication 832. In this case, the electronic device 400 may sort the orders of the first, second, and third application indications 831,832, and 871 based on priorities thereof (e.g., each frequency of use).

In the case where the third application indication 871 is selected, the electronic device 400 may connect to an application market, may download an installation file of the third service provider, and may install the installation file in the electronic device 400. Moreover, the electronic device 400 may provide the installed third service provider with permission to access the first health information, the second health information, and the third health information.

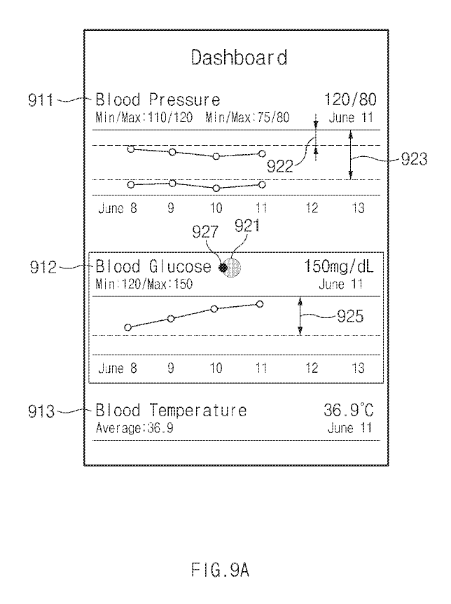

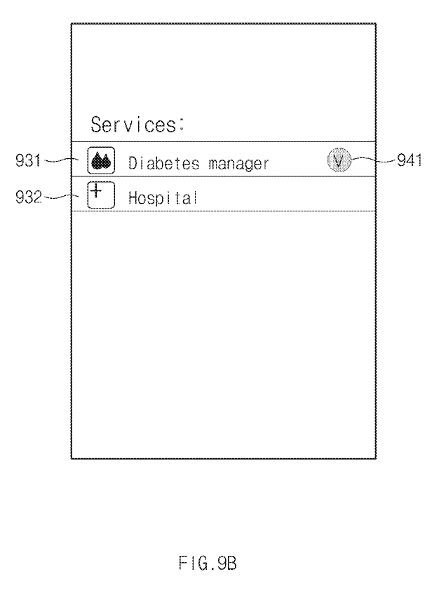

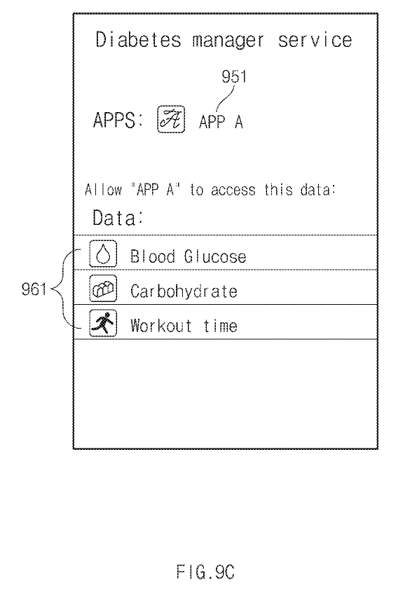

FIG. 9A illustrates a UI for displaying data associated with first health information, second health information, and third health information, according to various embodiments of the present disclosure.

The electronic device 400 may provide health data (e.g., health information history) corresponding to health information of a user. For example, the electronic device 400 may provide the health data based on a user request (e.g., a user input) for the health information. The health data may include data associated with the health information, for example, a name of the health information, a measurement data (e.g., a maximum value or a minimum value) corresponding to the health information, a normal or abnormal range corresponding to the health information, a date in which the health information is measured, or the like.

Referring to FIG. 9A, the first health information may be blood pressure information of the user, the second health information may be blood glucose information of the user, and the third health information may be blood temperature information of the user. For example, when blood pressure information is the first health information, a first health data 911 corresponding to the first health information, a “Blood Pressure”, which is a name of the first health information, “120/80”, which is a maximum value of a diastolic blood pressure of the user/a maximum value of a systolic blood pressure of the user, “110/120”, which is a minimum/maximum value of a systolic blood pressure of the user , “75/80”, which is a minimum/maximum value of a diastolic blood pressure of the user, “June 11”, which is a last date in which the blood pressure information is measured , or a measurement value graph displaying blood pressure information for each date on which the blood pressure information is measured may be displayed in the electronic device 400.

Additionally, for example, when blood glucose information is the second health information, a second health data 912 corresponding to the second health information, “Blood Glucose”, which is a name of the second health information, “150” which is a last measurement value of a user's blood glucose information, “120” being a minimum value and “150” being a maximum value of the user's blood glucose information, “June 11” being a last date in which the blood glucose information is measured, or a measurement value graph displaying blood glucose information for each date on which the blood glucose information is measured, may be displayed in the electronic device 400.

Furthermore, for example, when blood temperature information is the third health information, a third health data 913 corresponding to the third health information, “Blood Temperature”, which is a name of the third health information, “36.9” being a last measurement value and “36.9” being an average measurement value of the user's blood temperature information, or “June 11” being a last date in which the blood temperature information is measured, may be displayed in the electronic device 400.

According to an embodiment, when there is additional health information, which belongs to a specified range (e.g., an appropriate level), from among the first health information, the second health information, and the third health information, which are provided, the electronic device 400 may inform the user of the additional health information. For example, the electronic device 400 may display additional health data corresponding to the health information, which belongs to a specified range, from among the first to third pieces of health information by using a different display type than the display type of any other health data corresponding to the same health information.

For example, a normal range of the blood pressure information may be additional health information, when blood pressure information is the first health information. The normal range of the blood pressure information may be a systolic blood pressure of about 120 mmHg or less, and/or a diastolic blood pressure of about 80 mmHg or less. If the maximum value of the systolic blood pressure of the user on the first health information is 120 mmHg and the maximum value of the diastolic blood pressure thereof is 80 mmHg, the electronic device 400 may determine that the first health information does not correspond to abnormal ranges 922 and 923 (e.g., specified ranges). Accordingly, the electronic device 400 may not provide the user with additional information about the first health information.

For example, the normal range of the blood glucose information, when blood glucose information is the second health information, may be the additional information and may be from about 70 mg/dL to about 110 mg/dL. In the case where the minimum value of the second health information is 120 mg/dL and the maximum value thereof is 150 mg/dL, the electronic device 400 may determine that the second health information corresponds to an abnormal range 925 (e.g., the specified range). Accordingly, the electronic device 400 may display the second health data 912 by using a way to display (e.g., a way to draw a line along an edge), which is different from a way to display any other health data, so as to be distinguished from other health information.

According to an embodiment, for example where it is determined that the second health information corresponds to the abnormal range 925, the electronic device 400 may display an indication 927 (e.g., a user interface or a button) in an area corresponding to the second health data 912. According to an embodiment, the electronic device 400 may receive the user input 921 (e.g., the touch input 921 to the indication 927) for selecting the second health data 912 from the user. According to an embodiment, the electronic device 400 may automatically select the second health data 912. For example, the electronic device 400 may select the second health data 912 in response to the fact that the second health data 912 belongs to the specified range (e.g., an appropriate level or more).

FIG. 9B illustrates a plurality of service indications displayed when one of a number of pieces of health data displayed in FIG. 9A is selected, according to various embodiments of the present disclosure.

According to an embodiment, the UI illustrated in FIG. 9B may be displayed based on reception of the user input 921 for selecting the second health data 912 in FIG. 9A. According to an embodiment, the UI illustrated in FIG. 9B may be displayed based on the fact that the second health data 912 belongs to a specified range in FIG. 9A.

The electronic device 400 may arrange and display at least one service indication corresponding to at least one service that is capable of being provided by using the selected health information. Referring to FIG. 9B, the electronic device 400 may display a first service indication 931 corresponding to a first service and a second service indication 932 corresponding to a second service, which are capable of being provided by using the second health information. For example, the first service may be a diabetes management service, and the second service may be a hospital service.

The electronic device 400 may receive a user input 941 for selecting the first service. Furthermore, although not illustrated in FIG. 9B, the electronic device 400 may receive a user input to selecting the second service.

FIG. 9C illustrates a UI for displaying an application indication corresponding to at least one service provider, which is displayed when one of a plurality of services displayed in FIG. 9B is selected, and health information indications corresponding to pieces of health information used for at least one service provider to provide the selected service, according to various embodiments of the present disclosure.

According to an embodiment, the UI illustrated in FIG. 9C may be displayed based on reception of the user input 941 for selecting the first service indication 931 in FIG. 9B.

The electronic device 400 may arrange and display an application indication corresponding to a service provider that is capable of providing the selected service. Referring to FIG. 9C, the electronic device 400 may display an application indication 951 corresponding to the service provider that is capable of providing the first service. For example, a first service provider may be application ‘A’.

The UI illustrated in FIG. 9C may arrange a health information indication 961 corresponding to the health information used to provide a diabetes management service in a first service provider. For example, the health information may include blood glucose information (the second health information 912 illustrated in FIG. 9A), carbohydrate information, and workout time information.

The electronic device 400 may provide the first service provider with permission to access the health information based on a user input for selecting at least a part of the health information indication 961. According to various embodiments of the present disclosure, the electronic device 400 may assign the permission to access the health information to the first service provider based on the user input (e.g., a user input to the first application indication 951) for selecting the first service provider. Alternatively, the electronic device 400 may provide the UI illustrated in FIG. 9C based on the user input 941 (e.g., a user input to the first service indication) for selecting the first service in FIG. 9B and may assign the permission to access the health information to the first service provider. For example, the electronic device 400 may assign the permission to access the health information to the first service provider in substantial synchronization with providing the UI illustrated in FIG. 9C.

For example, when a service provider that is configured to provide the first service includes a plurality of service providers, the electronic device 400 may display the health information corresponding to a service provider, which is selected through a user input or automatically, from among the plurality of service providers. Moreover, the electronic device 400 may display the health information corresponding to all the service providers.

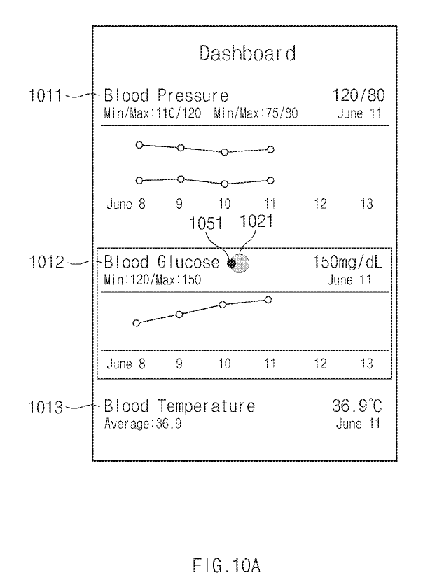

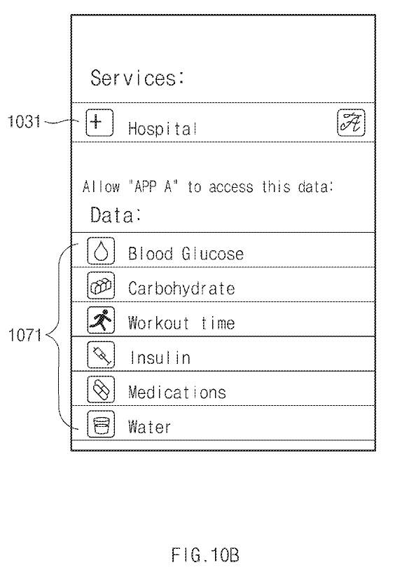

FIG. 10A illustrates a UI for displaying pieces of health data respectively corresponding to first health information, second health information, and third health information, according to various embodiments of the present disclosure. In addition, FIG. 10B illustrates a UI displayed in the case where one of pieces of health data displayed in FIG. 10A is selected (e.g., a UI for displaying a service indication corresponding to a service, an application indication corresponding to a service provider, and a health information indication corresponding to health information that is available to provide an arranged service), according to various embodiments of the present disclosure. Since FIGS. 10A and 10B correspond to FIGS. 9A to 9C, a detailed description given with reference to FIGS. 9A to 9C will not be repeated here.

In FIG. 10A, if first health data 1011 corresponding to first health information and third health data 1013 corresponding to third health information do not belong to a specified range (e.g., an abnormal value) and second health data 1012 corresponding to second health information belongs to the specified range, the electronic device 400 may display the first health data 1011 and the third health data 1013, for example, to be distinguished from the second health data 1012 (e.g., display the first health data 1011 and the third health data 1013 to be different from the second health data 1012 in color and size).

Referring to FIG. 10A, the electronic device 400 may receive a user input 1021 for selecting the second health data 1012. Referring to FIG. 10B, the electronic device 400 may arrange a service indication 1031 corresponding to a service, which uses the second health information, based on the user input 1021. The service may be, for example, a hospital service. Furthermore, according to an embodiment, the electronic device 400 may display an application indication 1051 for application ‘A’, which is capable of providing the service, by using the second health information together with a service indication 1031.

According to an embodiment, the electronic device 400 may arrange at least one health information indication 1071 corresponding to at least one health information that is available to provide the service in application ‘A’. The at least one health information may include, for example, blood glucose information, carbohydrate information, workout time information, insulin information, medications information, and water information.

According to an embodiment, comparing FIG. 10B with FIGS. 9B and 9C, an application indication corresponding to a service provider may be arranged in the UI of FIG. 10B together with a service indication corresponding to the service that uses the selected health information.

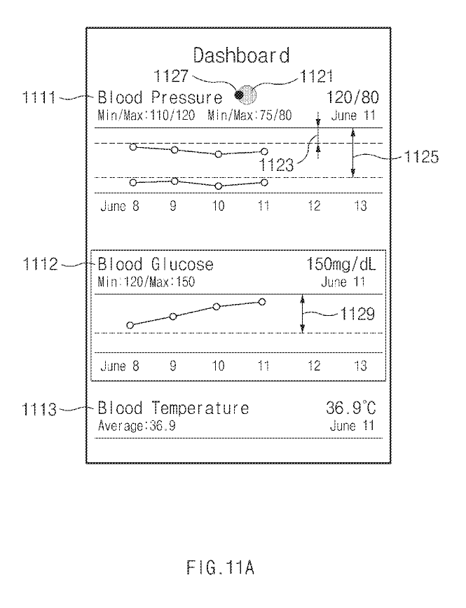

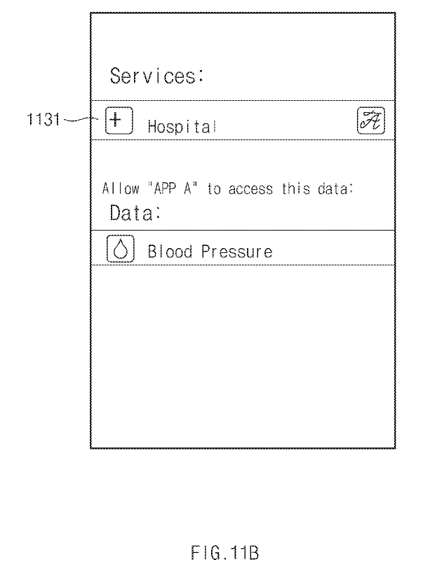

FIG. 11A illustrates a UI for displaying (e.g., arranging) health information indications corresponding to first health information, second health information, and third health information, according to various embodiments of the present disclosure. In addition, FIG. 11B illustrates a UI for displaying (e.g., arranging) an indication corresponding to a service displayed (e.g., arranged) in the case where one of pieces of health information displayed in FIG. 11A is selected, a service provider, and health information available to provide the displayed service, according to various embodiments of the present disclosure. Since FIGS. 11A and 11B correspond to FIGS. 10A and 10B, a detailed description given with reference to FIGS. 10A and 10B will not be repeated here.

In FIG. 11A, the electronic device 400 may display first health data 1111 corresponding to first health information, second health data 1112 corresponding to second health information, and third health data 1113 corresponding to third health information. The electronic device 400 may receive a user input 1121 for selecting the first health data 1111 of the first health data 1111, the second health data 1112, and the third health data 1113. Compared with FIG. 10A, the selected first health information of FIG. 11A may be, for example, health information that does not correspond to a specified range (e.g., a normal value that does not seem like an abnormal value).

For example, a normal range of blood pressure information, when the blood pressure information is the first health information, may be a systolic blood pressure of about 120 mmHg or less and a diastolic blood pressure of about 80 mmHg or less. For example, when a maximum value of the systolic blood pressure of a user is 120 mmHg and a maximum value of the diastolic blood pressure thereof is 80 mmHg, the electronic device 400 may determine that the first health information does not correspond to abnormal ranges 1123 and 1125 (e.g., specified ranges). Accordingly, the electronic device 400 may display an indication 1127 (e.g., an icon, an image, a video, or a text) indicating that the first health information does not correspond to the abnormal ranges 1123 and 1125. According to an embodiment, the electronic device 400 may provide additional information (e.g., a service or a service provider) corresponding to the first health information based, at least a part, on a user input 1121 corresponding to the indication 1127. For example, the normal range of the blood glucose information being the second health information may be from 70 mg/dL to 110 mg/dL. For example, where a minimum value of the second health information is 120 mg/dL and a maximum value thereof is 150 mg/dL, the electronic device 400 may determine that the second health information corresponds to an abnormal range 1129 (e.g., the specified range). Accordingly, the electronic device 400 may not display an indication (e.g., an icon, an image, a video, or a text) corresponding to the second health data 1112.

According to an embodiment, although not illustrated in FIG. 11A, the electronic device 400 may display an indication (e.g., an icon, an image, a video, or a text) indicating that the second health information corresponds to the abnormal range 1129. According to an embodiment, the electronic device 400 may provide (e.g., display) additional information (e.g., a service or a service provider) corresponding to the second health information based, at least a part, on a user input corresponding to the displayed indication.

Referring to FIG. 11B, according to an embodiment, the electronic device 400 may display (e.g., arrange) a service indication 1131 corresponding to the service, which uses the first health information, based on the user input 1121 (as in FIG. 11A). According to an embodiment, for example, the electronic device 400 may automatically display the service indication corresponding to the service, which uses the first health information, based on the fact that the first health information belongs to a specified range (e.g., a normal range). The service may be, for example, a hospital service. Furthermore, according to an embodiment, the electronic device 400 may display an application indication corresponding to application ‘A’ (e.g., a medical application or a hospital reservation application) being a service provider, which is capable of providing the service by using the first health information, together with the service indication. According to an embodiment, the electronic device 400 may display (e.g., arrange) health information indication corresponding to the health information that is available to provide the service in application ‘A’. The displayed (e.g., arranged) health information may include, for example, blood pressure information.

Comparing FIG. 11B with FIG. 10B, the electronic device 400 may differentiate pieces of information that are provided to respectively correspond to health information of a normal value and health information of an abnormal value.

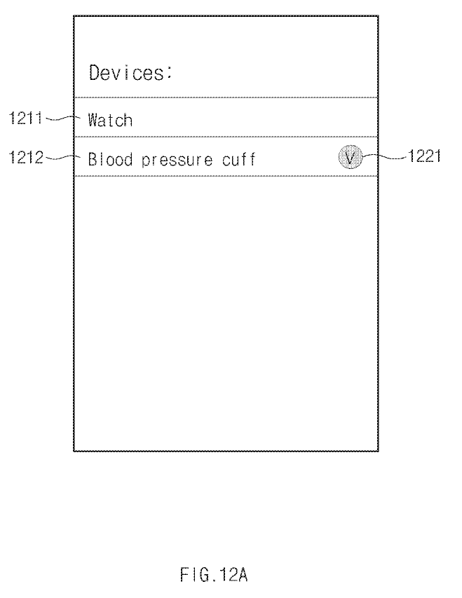

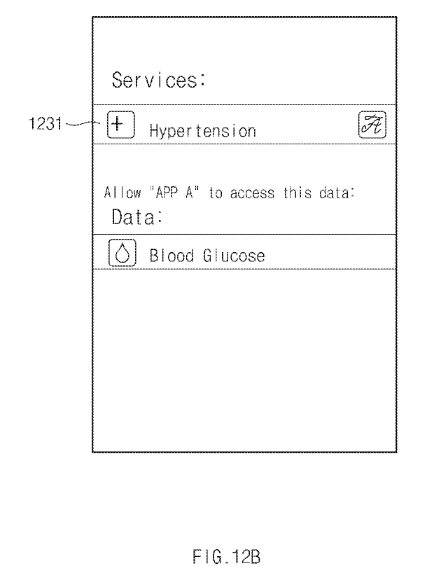

FIG. 12A illustrates a UI for displaying (e.g., arranging) indications corresponding to a plurality of electronic devices connected with an electronic device, according to various embodiments of the present disclosure.

Referring to FIG. 12A, the electronic device 400 may be connected (e.g., connected through wired or wireless communication or physically connected) with a first electronic device and a second electronic device. According to an embodiment, the electronic device 400 may display a first device indication 1211 corresponding to the first electronic device and a second device indication 1212 corresponding to the second electronic device based, at least a part, on the fact that the first electronic device and the second electronic device are connected with the electronic device 400. According to an embodiment, the electronic device 400 may display the first device indication 1211 or the second device indication 1212 based on the fact that information about the first electronic device or the second electronic device is registered (e.g., stored) in the electronic device 400.

For example, the first electronic device may be a smart watch, and the second electronic device may be a blood pressure measuring device. The first device indication 1211 may include, for example, a name, an icon, an image, a video, or a text that corresponds to the first electronic device. The second device indication 1212 may include, for example, a name, an icon, an image, a video, or a text that corresponds to the second electronic device.

The electronic device 400 may receive a user input 1221 for selecting the second electronic device. The user input 1221 may include, for example, may include a touch input, a hover input, or a force touch input corresponding to the second device indication 1212.

FIG. 12B illustrates a UI for displaying an indication corresponding to a service, which are capable of being provided through an electronic device selected in FIG. 12A, a service provider, and health information, according to various embodiments of the present disclosure.

For example, the electronic device 400 may display a service indication 1231 corresponding to service (e.g., a hypertension measurement service), which is capable of being provided through the second electronic device 1212, or an application indication corresponding to a service provider (e.g., application ‘A’), which provides a service, based, at least a part, on the user input 1221 or automatically. Moreover, the electronic device 400 may display a health information indication corresponding to health information (e.g., blood glucose information) used to provide a service in application ‘A’.

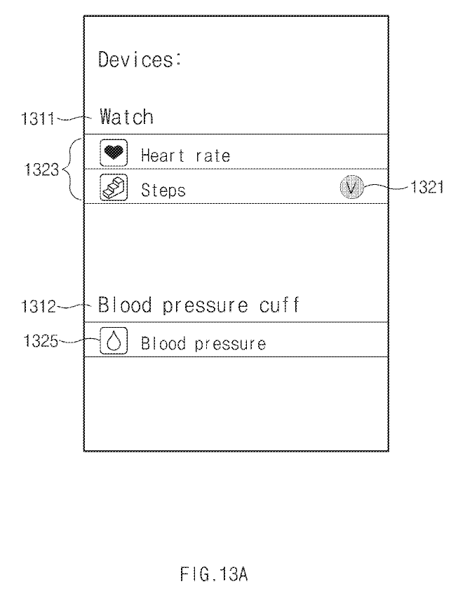

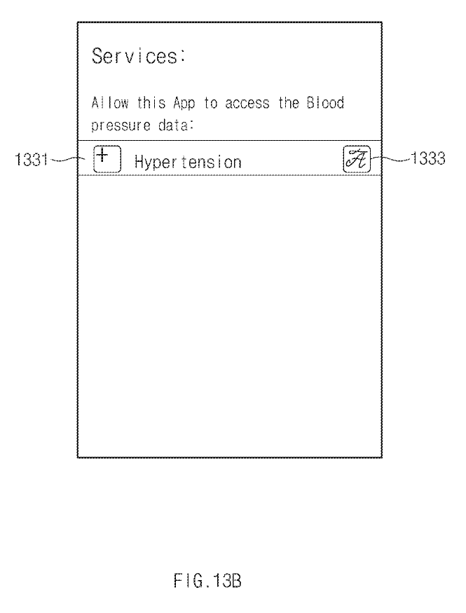

FIG. 13A illustrates a UI for displaying (e.g., arranging) a plurality of electronic devices connected with an electronic device and indications corresponding to pieces of health information used in a service, which is capable of being provided through each of the plurality of electronic devices, according to various embodiments of the present disclosure.

Referring to FIG. 13A, the electronic device 400 may be connected (e.g., connected through wired or wireless communication or physically connected) with a first electronic device and a second electronic device. According to an embodiment, the electronic device 400 may display a first device indication 1311 corresponding to the first electronic device and a second device indication 1312 corresponding to the second electronic device based, at least a part, on the fact that the first electronic device and the second electronic device are connected with the electronic device 400. According to an embodiment, the electronic device 400 may display the first device indication 1311 or the second device indication 1312 based on the fact that information about the first electronic device or the second electronic device is registered (e.g., stored) in the electronic device 400.

For example, the first electronic device may be a smart watch, and the second electronic device may be a blood pressure measuring device. In addition, the electronic device 400 may display health information, for example, the first health information indication 1323 corresponding to heart rate information or stair exercise information, which is used in a service capable of being provided through the first electronic device, in an area (e.g., an upper area, a lower area, a right area, or a left area of an area in which the first device indication 1311 is displayed) that is associated with the area in which the first device indication 1311 is displayed). For example, the electronic device 400 may temporarily simultaneously display the first device indication 1311 and the first health information indication 1323.

In addition, for example, the electronic device 400 may display health information, for example, the second health information indication 1325 corresponding to blood pressure information, which is used in a service capable of being provided through the second electronic device, in an area (e.g., an upper area, a lower area, a right area, or a left area of an area in which the second device indication 1312 is displayed) that is associated with the area in which the second device indication 1312 is displayed). For example, the electronic device 400 may temporarily simultaneously display the second device indication 1312 and the second health information indication 1325.

The electronic device 400 may receive a user input 1321 for selecting the second electronic device. The user input 1321 may include, for example, a touch input, a hover input, or a force touch input that corresponds to the second device indication 1312 or the second health information indication 1325.

FIG. 13B illustrates a UI for displaying an indication corresponding to a service, which uses health information selected in FIG. 13A, and a service provider that provides the service, according to various embodiments of the present disclosure.

The electronic device 400 may display a service indication 1331 corresponding to service, which is capable of being provided through the second electronic device, or an application indication 1333 corresponding to a service provider (e.g., application ‘A’), which provides a service, based, at least a part, on the user input 1321 or automatically. For example, the service indication 1331 and the application indication 1333 may be at least temporarily simultaneously displayed. For example, the service that is capable of being provided may be a hypertension service, and a service provider that provides the hypertension service may be application ‘A’.

According to various embodiments of the present disclosure, the electronic device 400 may display an indication corresponding to a service, which uses health information selected through FIG. 13B, and a service provider by selecting one of a number of pieces of health information in FIG. 13A.

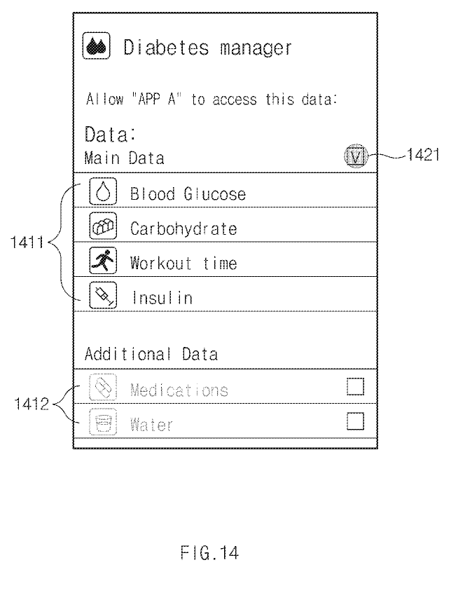

FIG. 14 illustrates a UI for displaying (e.g., arranging) indications corresponding to pieces of health information that a service provider uses to provide the selected service, according to various embodiments of the present disclosure.

Referring to FIG. 14, for example, the electronic device 400 may at least temporarily simultaneously display a first health information indication 1411 corresponding to minimum health information, which a service provider makes use of to provide a service (e.g., a diabetes management service), and second health information indication 1412 corresponding to additional health information.

The service provider that provides the service (e.g., the diabetes management service) by using first health information corresponding to the minimum health information may be, for example, application ‘A’. The electronic device 400 may provide application ‘A’ with permission to access the minimum health information based on a user input 1421 for selecting the minimum health information. The user input 1421 may include, for example, a touch input, a hover input, or a force touch input that corresponds to the first health information indication 1411.

According to an embodiment, if a user selects a piece of health information included in the additional health information, the electronic device 400 may display an application indication corresponding to the service provider that uses the minimum health information and the selected health information. The electronic device 400 may assign the permission to access the minimum health information and the selected health information to the service provider.

According to an embodiment, in the case where the user selects a piece of health information included in the additional health information, the electronic device 400 may inform the user whether to allow the service provider to access the additional health information in addition to the minimum health information. For example, the electronic device 400 may provide a notification (e.g., a text display indicating that “there is no need for the selected health information to receive the service”), vibration, or sound based, at least a part, on, the fact that the user selects one health information included in the additional health information and the electronic device 400 receives the selected health information.

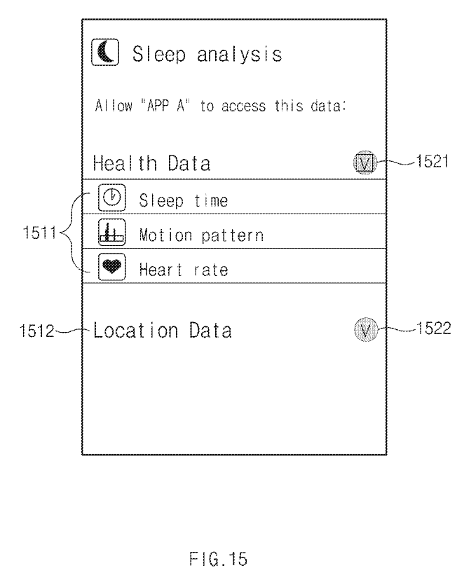

FIG. 15 illustrates a UI for determining health information, of which access permission is assigned to a service provider, and other pieces of information through a user input, according to various embodiments of the present disclosure.

Referring to FIG. 15, the electronic device 400 may display a health information indication 1511 corresponding to health information, which will be used for a service provider (e.g., application ‘A’) to provide the selected service (e.g., a sleep analysis service), or an additional information indication 1512 corresponding to additional information. In this case, the electronic device 400 may receive a touch input, a hover input, or a force touch input that corresponds to a user input 1521 (e.g., the health information indication 1511) for selecting only the health information. In addition, the electronic device 400 may receive a touch input, a hover input, or a force touch input that corresponds to a user input 1522 (e.g., the additional information indication 1512) for selecting only the additional information 1512. Furthermore, the electronic device 400 may receive the user input 1521 for selecting the health information together (e.g., at least temporarily simultaneously) with the user input 1522 for selecting the additional information. The additional information 1512 may be, for example, location information.

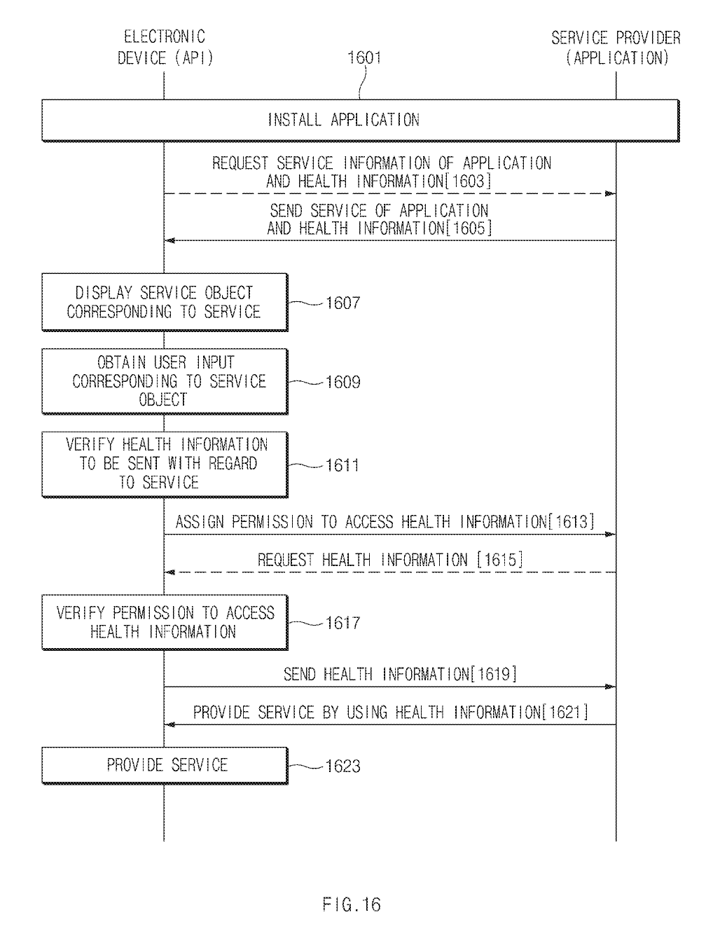

FIG. 16 is a flowchart illustrating an operation performed in providing a service between an application program interface (API) (alternatively, an application or middleware) of an electronic device and a service provider, according to various embodiments of the present disclosure. The operation of FIG. 16 performed in providing the service between the API of the electronic device and the service provider may be performed by the electronic device 400 (e.g., the electronic device 101 or 201 or the program module 310) described above with reference to FIGS. 1 to 15. Accordingly, although not described in FIG. 16, the operation performed in the electronic device 400 described in FIGS. 1 to 15 may be applied to the operation performed in providing the service between the API (e.g., the API 145 of FIG. 1) of the electronic device 400 in FIG. 16 and the service provider (e.g., the application 147 of FIG. 1).

In operation 1601, the application may be installed in the memory 499 of the electronic device 400.

In operation 1603, the API may request a service, which is capable of being provided from the application, or health information, which is necessary for the service, from the service provider.

In operation 1605, the service provider may send, to the API, the service that is capable of being provided from the application and is requested in operation 1603, or the health information.

In operation 1607, the API may display a service indication corresponding to the service that is capable of being provided from the application.

In operation 1609, the API may receive a user input for selecting one of at least one or more service indications that are capable of being provided from the application.

In operation 1611, the API may verify the health information used to provide the service selected in operation 1609.

In operation 1613, the API may assign permission to access the health information, which is verified in operation 1611, to the service provider.

In operation 1615, the service provider may request the health information from the API.

In operation 1617, the API may verify whether the service provider has the permission to access the corresponding health information, based on a request for the health information received in operation 1615.

In operation 1619, the API may send the requested health information to the service provider in response to the request for the health information received in operation 1615.

In operation 1621, the service provider may provide the service to the API by using the health information sent in operation 1619.

In operation 1623, the API may provide a user with the service.

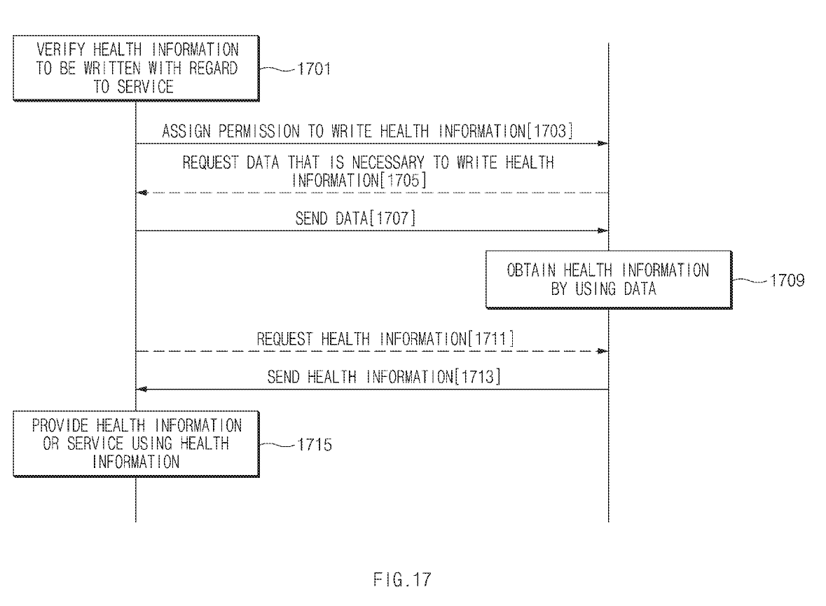

FIG. 17 is a flowchart illustrating an operation performed in service provision between an API (alternatively, middleware or an application) of an electronic device and a service provider, according to various embodiments of the present disclosure. The operation performed in the service provision between the API of the electronic device illustrated in FIG. 17 and the service provider may be performed by the electronic device 400 (e.g., the electronic device 101 or 201 or the program module 310) described above with reference to FIGS. 1 to 15. Accordingly, in spite of contents that are not described in FIG. 17, the operation performed by the electronic device 400 described in FIGS. 1 to 15 may be applied to the operation performed in the service provision between the API (e.g., the API 145 of FIG. 1) of the electronic device 400 in FIG. 17 and the service provider (e.g., the application 147 of FIG. 1).

According to an embodiment, operation 1701 may be performed after operation 1609 of FIG. 16.

In operation 1701, the API may verify health information to be written with regard to the service selected in operation 1609.

In operation 1703, the API may assign permission to write the health information, which is verified in operation 1701, to the service provider. The write permission may be permission that allows the service provider to update the health information stored in the memory 499.

In operation 1705, the service provider may request data, which is necessary to write the health information verified in operation 1701, from the API.

In operation 1707, the API may send the data, which is requested in operation 1705, to the service provider.

In operation 1709, the service provider may obtain health information by using the data sent in operation 1707. The obtained health information may be the health information verified in operation 1701.

In operation 1711, the API may request the health information, which is obtained in operation 1709, from the service provider.

In operation 1713, the service provider may send the health information, which is requested in operation 1711, to the API. According to various embodiments of the present disclosure, operation 1713 may be performed without operation 1711 immediately after the health information is obtained in operation 1709.

In operation 1715, the API may provide a user with the health information sent in operation 1713 or the service using the health information. In this case, the received health information may be stored in the memory 499.

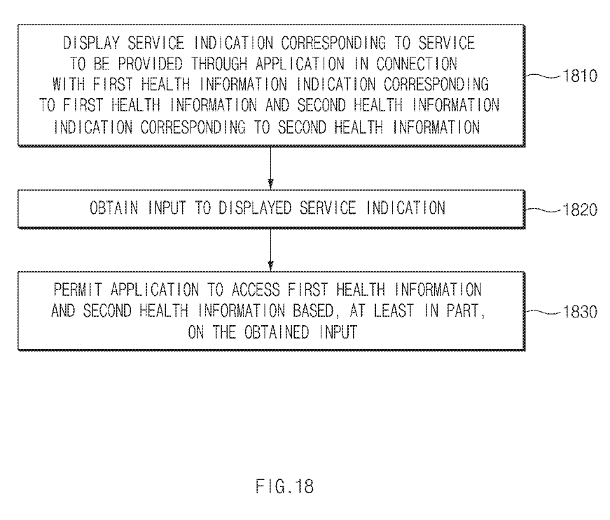

FIG. 18 is a flowchart illustrating an operation in which an electronic device permits an application to access health information, according to various embodiments of the present disclosure. The operation in which the electronic device illustrated in FIG. 18 permits the application to access the health information may be performed by the electronic device 400 (e.g., the electronic device 101 or 201, the processor 120, 210, 490, or the program module 310) described above with reference to FIGS. 1 to 15. Accordingly, in spite of contents that are not described in FIG. 18, the operation performed by the electronic device 400 described in FIGS. 1 to 15 may be applied to the operation in which the electronic device of FIG. 18 permits the application to access the health information.

In operation 1810, the electronic device 400 may display a service indication (e.g., a text indicating the “sleep management service”) corresponding to the service (e.g., a “sleep management service”) to be provided through the application in connection with a first health information indication (e.g., an icon in the “sleep time”) corresponding to first health information (e.g., a “sleep time”) and a second health information indication (e.g., an icon indicating the “motion pattern”) corresponding to second health information (e.g., a “motion pattern”).

For example, the electronic device 400 may display the service indication in a first area of a display and may display the first health information indication and the second health information indication in a second area (e.g., a lower area of the first area) that is close (e.g., adjacent) to the first area. For example, the electronic device 400 may display the service indication through the display. In the case where an input (e.g., a touch on an area in which the service indication is displayed) corresponding to the service indication is sensed, the electronic device 400 may simultaneously or sequentially display the first health information indication and the second health information indication through the display.

In operation 1820, the electronic device 400 may obtain a user input to the service indication displayed in operation 1810.

In operation 1830, the electronic device 400 may permit the application to access the first health information and the second health information based, at least a part, on the user input obtained in operation 1820. For example, the electronic device 400 may allow the application to obtain the first health information and the second health information. Moreover, the electronic device 400 may allow the application to write or revise the first health information and the second health information.

The term “module” used herein may represent, for example, a unit including one or more combinations of hardware, software and firmware. The term “module” may be, for example, interchangeably used with the terms “unit”, “logic”, “logical block”, “component” and “circuit”. The “module” may be a minimum unit of an integrated component or may be a part thereof. The “module” may be a minimum unit for performing one or more functions or a part thereof. The “module” may be implemented mechanically or electronically. For example, the “module” may include at least one of an application-specific IC (ASIC) chip, a field-programmable gate array (FPGA), and a programmable-logic device for performing some operations, which are known or will be developed.

At least a part of an apparatus (e.g., modules or functions thereof) or a method (e.g., operations) according to various embodiments of the present disclosure may be, for example, implemented by instructions stored in a computer-readable storage media in the form of a program module. The instruction, when executed by one or more processors (e.g., a processor 120), may cause the one or more processors to perform a function corresponding to the instruction. The computer-readable storage media, for example, may be the memory 130.

A computer-readable recording medium may include a hard disk, a floppy disk, a magnetic media (e.g., a magnetic tape), an optical media (e.g., a compact disc read only memory (CD-ROM), a digital versatile disc (DVD), or a magneto-optical media (e.g., a floptical disk)), and a hardware device (e.g., a read only memory (ROM), a random access memory (RAM), or a flash memory). Also, a program instruction may include not only a mechanical code such as things generated by a compiler but also a high-level language code executable on a computer using an interpreter. The above hardware unit may be configured to operate via one or more software modules for performing an operation of the present disclosure, and vice versa.

According to various embodiments, an electronic device and a method thereof may identify (e.g., group) a health information indication corresponding to at least one health information stored in the electronic device for respective service to be provided through an application and may display the health information indication. For example, in the case where a first service and a second service are provided through the application, the electronic device may display the first health information, which is necessary to provide the first service, from among at least one health information in connection with a service indication corresponding to the first service. In addition, the electronic device may display the second health information, which is necessary to provide the second service, in connection with a service indication corresponding to the second service. Accordingly, it is easy for a user to determine what is health information, which is necessary for a service provided through the application, from among at least one health information.

The electronic device may allow the application to access only the health information, which is necessary for the service, from among at least one health information based on a user input to the service indication. Accordingly, the user may easily select only the health information, which is necessary for the service to be received, as information that the application is capable of accessing. In addition, other health information that is unnecessary to provide a specific service is prevented from being leaked to the application.

According to various embodiments of the present disclosure, an electronic device and a method thereof may display information used to provide a health management service so as to be identified for each case.

A module or a program module according to various embodiments of the present disclosure may include at least one of the above elements, or a part of the above elements may be omitted, or additional other elements may be further included. Operations performed by a module, a program module, or other elements according to various embodiments of the present disclosure may be executed sequentially, in parallel, repeatedly, or in a heuristic method. Also, a part of operations may be executed in different sequences, omitted, or other operations may be added.

Although the present disclosure has been described with various exemplary embodiments, various changes and modifications may be suggested to one skilled in the art. It is intended that the present disclosure encompass such changes and modifications as fall within the scope of the appended claims.

What is claimed is:

1. A method performed by an electronic device, the method comprising:
displaying, on a display operatively connected to the electronic device, a first service indication corresponding to a first service to be provided through an application, wherein the first service indication is being displayed with a first health information indication corresponding to first health information and a second health information indication corresponding to second health information;
obtaining an input in response to the displayed first service indication; and
allowing the application access to the first health information and the second health information based on the input.

2. The method of claim 1, wherein the displaying comprises:
at least temporarily, simultaneously displaying a second service indication corresponding to a second service to be provided through the application together with:
the first service indication, and
a third health information indication corresponding to third health information.

3. The method of claim 2, wherein the at least temporarily, simultaneously displaying comprises:
displaying the first service indication in a first area of the display, and
displaying the second service indication in a second area of the display.

4. The method of claim 1, wherein the displaying comprises:
in response to at least one of the first health information or the second health information being in a specified range, displaying the first service indication corresponding to the first service, wherein the first service is among a plurality of services configured to be provided through the application or another application.

5. The method of claim 1, further comprising:
selecting the first health information and the second health information from among a number of pieces of health information corresponding to the application,
wherein the first health information and the second health information correspond to the first service, and
wherein selecting the first health information and the second health information is performed prior to displaying the first service indication corresponding to the first service.

6. The method of claim 1, further comprising: in response to at least one health information among the first health information or the second health information being in a specified range, selecting the first health information and the second health information from among a number of pieces of health information corresponding to the first service, and
wherein the selecting is performed prior to the displaying.

7. The method of claim 1, further comprising:
verifying an external electronic device electrically connected with the electronic device and configured to provide a plurality of services including the first service; and
selecting the first service from among the plurality of services,
wherein the verifying and the selecting are performed prior to the displaying.

8. The method of claim 1, wherein the allowing is performed further based on one of:
a first input to the application, or
a second input to the first health information and the second health information.

9. The method of claim 1, wherein the displaying further comprises:
displaying a first application indication corresponding to the application; and
displaying a second application indication corresponding to another application configured to provide the service.

10. The method of claim 1, further comprising:
verifying another application corresponding to the first health information and the second health information; and
displaying an application indication corresponding to the another application,
wherein the verifying the another application and the displaying the application indication are performed prior to the obtaining the input.

11. An electronic device comprising:
a memory configured to store a first service indication corresponding to a first service to be provided through an application; and
a processor configured to:
display the first service indication, wherein the first service indication is being displayed with a first health information indication corresponding to first health information and a second health information indication corresponding to second health information, through a display operatively connected with the processor;
obtain an input in response to the displayed first service indication; and
allow the application access to the first health information and the second health information based on the input.

12. The electronic device of claim 11, wherein the processor is configured to:
display, through the display, a first object corresponding to the service in a first area of the display; and
display, through the display, a second object corresponding to the first health information and the second health information in a second area corresponding to the first area.

13. The electronic device of claim 11, wherein the processor is configured to:
display, through the display, a first object corresponding to the application; and
display, through the display, a second object that corresponds to another application configured to provide the service corresponding to the first health information and the second health information.

14. The electronic device of claim 11, wherein the processor is configured to further display, through the display, other information necessary to provide the service.

15. An electronic device comprising:
a display circuit configured to display a health management user interface (UI);
a user input circuit configured to obtain a user input from a user; and
at least one processor electrically connected with the display circuit and the user input circuit,
wherein the at least one processor is configured to:
group at least one health information item, which corresponds to at least one service that a health management application is capable of providing, from among a plurality of health information items;
in response to obtaining user input through the health management UI, select the grouped at least one health information; and
provide the health management application with permission to access the selected at least one health information.

16. The electronic device of claim 15, wherein the permission to access comprises at least one of permission to use or permission to revise the grouped at least one health information item in the health management application.

17. The electronic device of claim 15, wherein the at least one processor is configured to group into different groups, at least one health information item corresponding to each of
a first service, which a first health management application is capable of providing, and
the first service, which a second health management application is capable of providing.

18. The electronic device of claim 15, wherein the at least one processor is configured to display, on the health management UI, at least some of:
a list of health management applications installed in the electronic device,
a list of services capable of being provided for each of the health management applications in the list of health management applications, and
a list of health information items grouped for each of the services in the list of services.

19. The electronic device of claim 18, wherein the at least one processor is configured to display, in response to a user input for selecting a first health management application from among the listed health management applications, display a second list comprising:
the listed services capable of being provided by the selected first health management application, and
the listed health information items grouped for each of the listed services.

20. The electronic device of claim 18, wherein the at least one processor is configured to:
display, in response to a user input for selecting a first service from among the listed services, a second list of health management applications capable of providing the selected first service; and
display, in response to a user input for selecting one health management application in the displayed second list, a third list of the health information items that are grouped to correspond to the selected first service and the selected one health management application.
